(19) United States
(12) Patent Application Publication
(10) Pub. No.: US 2012/0109777 A1
(43) Pub. Date: May 3, 2012

(54) SYSTEM FOR CREATING AND MAINTAINING E-COMMERCE USER STORES FOR CUSTOM AND CUSTOMIZABLE PRODUCTS

(75) Inventors: Ethan Andrew Lipsitz, Los Angeles, CA (US); Emily Kate Gruber, Los Angeles, CA (US); Harry Edward Gruber, San Diego, CA (US)

(73) Assignee: Apliiq, Inc., Los Angeles, CA (US)

(21) Appl. No.: 13/282,855

(22) Filed: Oct. 27, 2011

Related U.S. Application Data
(60) Provisional application No. 61/456,189, filed on Nov. 1, 2010.

(51) Int. Cl. G06Q 30/06

(52) U.S. Cl. 705/26.5

(57) ABSTRACT

Users access a computer system using a network to customize products offered by selecting from a library of customizing components and applying the components to the products. Data indicative of customized products created by the users is stored in a database. The users can purchase their customized products and/or create an online store to offer and sell their customized products to others. Other users can access the computer system and the online stores to create sub-stores to sell sub-customized products. The stores and sub-stores can provide all of the products and customizing components or just subsets thereof. The online stores and sub-stores can be linked to social media sites and/or be embedded in other web sites. The system can be used with any customizable product including, for example, clothing that is customized with appliqué patches.

This application claims the benefit of U.S. Provisional Application No. 61/456,189 filed on Nov. 1, 2010, the entire contents of which is hereby incorporated by reference.

### BACKGROUND OF THE INVENTION

The present invention relates to a “Multi-Channel” and “Multi-Tier” computer system with software and a supporting database for building custom stores to sell customizable items or groups of items online. The term “Multi-Channel” is used herein to refer to an unlimited number of selling “Channels.” The term “Multi-Tier” is used herein to refer to a Channel that can have an unlimited number of subsidiary Channels, called “Tiers.”

The customization of goods through online websites is available for various consumer products. Major shoe companies like Nike® (NikeiD), Keds® (Keds Collective) and Reebok® (RBK Custom) offer their customers the ability to design their own shoes, choosing the colors and graphic details to make their own one of a kind footwear. From cars (BMW®) to computers (Dell®) to candies (My M&M®), the ability to personalize a consumer good (“Product”) to fit an individual's needs or tastes is available in the online marketplace.

Another e-commerce trend has evolved from websites like EBay® allowing Internet users to easily buy and sell goods online by setting up their own stores or auctions.

Websites like Zazzle® have combined the opportunity for users to customize Products that Zazzle offers with the opportunity to sell those Products to earn a commission.

Despite the aforementioned websites, to date no means have been available to enable Internet users to sell customizable Products in which a Product customization tool is provided that can be personalized for each user's own online point of sale. Such a system would be advantageous, particularly if it were to place the customization controls in the hands of many people, i.e., online “Users.”

It would be further advantageous to provide a system wherein the managers thereof (the “Company”) serve to facilitate the generation of custom Product by offering Users a stock of variable pieces (“Components”) from a library of such Components for application to and customizing of pre-designed, pre-made, generic wholesale items (“Bases”). The result will be the creation of a finished Product. Components would add value to Bases and could advantageously be mixed and matched, designed, and personalized as desired by Users. Furthermore, it would be advantageous for the Company to use an almost instantaneous real time (or “Just-in-Time”) manufacturing process where each Product is manufactured one at a time after a Customer purchases the specific Product (composed of a Base and various Components).

It would also be advantageous to provide a computerized business process automation system with associated software and database to fulfill Product Orders in a timely, cost-effective and accurate way (“Order Management”). Still further, it would be advantageous to provide a computerized software and database system that allows Users to personalize the look and feel of their own Stores and Customizers (defined in greater detail below), as well as the Product and Component offerings. In such an advantageous system, Users should be able to select finished Products from other Users' Stores or design their own Products. For their Customizers, Users should be able to select specific Components to be customized by other Users.

Advantageously, a meta database would be in place for Users to select tagged data and apply rules to the overarching system. In this way, a User could mix and match features depending on simple commands to create clusters of custom Product options that fall within certain parameters. The meta database and software system should also allow for the creation of an automatic search and directory function so Users, consumers, and organizations can find other Users' custom Products. Furthermore, it would be advantageous for the system to allow a User to sell alongside other Users, and/or on behalf of another User, and/or to have Users selling on his/her behalf.

The advantage of giving Users the control of their Stores and Customizers would be especially relevant for Users who base their stores around a particular theme. For example, if a User wanted to make a Store for only black and white Products because that was his/her school, organization or corporate colors, it would be advantageous if he/she could set parameters in his/her “Store Owner Controls” so only black and white Products appear in his/her Store. Similarly, it would be advantageous if a User could select specific black and white Components for his/her Customizer so that his/her Customers may customize a Product with only black and white Components. In this way, Users could offer customizable Products that still fall within their chosen theme, cause or affiliation.

Prior art systems for Product customization and user selling will not work to achieve the advantages mentioned above. Instead, there is a need for a complex Multi-Tier and Multi-Channel computer system with software and an associated database that can accept a virtually unlimited number of variables to be combined in a virtually unlimited number of ways to create custom Products sold through personalized displays of products (“Stores”) and Customizers.

The present invention provides a system with the aforementioned advantages, and allows Internet Users to create their own custom selling environments (“Customizers”) that cater to their needs such as targeting certain demographics or themes based around specific Product lines with specific Product based parameters.

### SUMMARY OF THE INVENTION

In accordance with the present invention, a novel computer system is provided with integrated software components and a database for use in building custom Stores for selling customizable Products or groups of Products online. A preferred embodiment of the invention includes software to input essentially unlimited items for customization and corresponding meta tags into the database (“Product Management”) which then generates an output of two types: 1) a Store for Users to browse, search, and filter a virtually unlimited directory of Products and view a simple grid-like display of Products and 2) a Customizer for Users to customize their own distinct Products by viewing variables in a segmented process to alter a basic Product. In either output, Users can purchase Products and the specific parts that compose a Product are transferred through the database to the Order Management system.

The Order Management system is an automated system that takes input directly from a Customer's Order and simultaneously facilitates (a) buying all Components of several Products, (b) manufacturing of several Products, (c) generating shipping labels and tracking information for Customers, (d) finding, notating and resolving errors and issues providing an integrated “Customer Service” system, and (e) feeding the information from a Customer's Order through the database out to an “Accounting” report system to pay “Suppliers” for wholesale goods, pay “Manufacturers” for assembling the wholesale goods into finished Products, and allow the Company to view and track sales records. Furthermore, the computerized software and database system of the invention supports a Multi-Tiered and Multi-Channel customizable selling unit for customized and customizable Products.

A preferred embodiment unveils several novel features in the display of the outputs of every Channel and Tier of Stores and Customizers. For example, each virtual image rendering of a Product is a complex series of layers that gives Users the impression that his/her selections have created a physical Product, which is realistically displayed on a real model. In fact, the Product has not been physically created, nor photographed on a model. Since the software and database drive the compilation of layers to create a single Product rendering, it is possible to swap specific layers and maintain other layers simultaneously. In this way, one advantage of the invention is that Users can see a realistic photographic virtual image rendering of any Product on an unlimited number of models in several views. Another innovative feature of the preferred embodiment regarding the display of Products is an inventory meter that reflects the quantity of a particular Component, as described below in connection with the “Fabric Meter.”

The custom Product Customizer is a computerized Multi-Channel and Multi-Tier online system comprising software and a supporting database with a series of controls that enable website Store Owners to sell customizable Products and set parameters for how Users design their Products. Store Owners can determine which database fields display in their Customizers and therefore which Components and essentially which Products their Users can view and customize. In a preferred embodiment, such fields are arranged in a way that enables the Store Owner to easily choose the features they want to display in his/her Customizer and forgo those which he/she wants to hide. In the preferred embodiment, in addition to selecting Components for his/her Customizer, a User can personalize the layout and theme of his/her Customizer.

Furthermore, the computerized Multi-Channel and Multi-Tier system with the associated software and database allows a complex network of hierarchy among Store Owners. In a preferred embodiment, a Store Owner receives emotional and financial rewards for selling Products and may have reason to join together with other sellers to accomplish a desired goal through unified and widespread selling. In another case, a single Store Owner may have an unlimited number of subsidiary “Sub-Stores,” or Store Owners who have their own Stores that sell on his/her behalf. For example, an organization may enlist an unlimited number of Store Owners to further the reach of marketing and selling capabilities. Store Owners can decide how to reward their Sub-Stores through their personal Store Owner Controls. As there can be an unlimited number of Store Owners and Stores (or Channels) and there can be an unlimited number of Sub-Stores (or Tiers), a Multi-Channel and Multi-Tier system must keep track of the numerous connections between Store and Sub-Stores and the corresponding settings for rewards.

The system of the present invention can be used to build online Stores that allow for the design and sale of, e.g., customized garments. Examples of customized garments include those produced from a Base garment such as a plain hoody, t-shirt, tank top, sweater or dress in a selected color and size with one or more fabrics in one or more shapes (“Patches”) sewn onto the Base garment in one or more locations. Other examples include using consumer designed and uploaded designs to be printed on the Base garment or on the fabric that is sewn onto the Base garment.

More particularly, a computer system is provided for creating and maintaining customized online stores. The system includes a computer processor, a database associated with the processor, and software adapted to run on the processor. Data is stored in and retrieved from the database to enable users to customize products offered via the computer system. Data defining customized products created by the users is also stored in the database. The computer system further enables the users to create online stores to offer and sell their customized products to others. The database stores data representative of the online stores in addition to the customized products to be offered and sold via the online stores. This data is used by the computer system in operating and maintaining the online stores.

A user interface operatively associated with the software and processor enables first users to select subsets of product components (e.g. bases and fabrics as explained in further detail below) and/or store components (e.g., fashion models to depict custom garments being worn) offered via the computer system to create the online stores. The online stores enable second users to create custom products using the subset of product components selected for that store.

Users are enabled to customize products offered via the computer system and/or via online stores to create sub-customized products. The users creating sub-customized products are enabled to create online sub-stores to offer and sell their sub-customized products to others.

The user interface provides a selection of product components to the users for customizing the products offered via the computer system. A selection of store components is also provided by the interface to allow users to customize the online stores they create. For example, the “store components” can comprise different fashion models that can be depicted wearing different clothing bases (e.g., hoodies, sweaters, tank tops, tees, sweatshirts, etc.) that can be customized using different fabric swatches. In this example, the clothing bases and fabric swatches are referred to as “product components.” Users (who are typically different users than those who created the aforementioned online stores) are enabled to customize products offered via the online stores to create sub-customized products. The users creating sub-customized products are enabled to create their own online sub-stores to offer and sell their sub-customized products to others. It should be appreciated that such users can also sell the products of others via their sub-stores, and receive a commission for such products.

The user interface can also enable users to select a subset of the product components to present on their online stores. Users (e.g., persons other than the user that set up the online store) can be enabled to customize products offered via the online stores to create sub-customized products using the subset of product components. The users creating sub-customized products can be enabled to create online sub-stores to offer and sell their sub-customized products to others. The user interface can enable the users creating sub-customized products to select a further subset of the product components to present on an online sub-store. There can be any number of online stores, sub-stores, sub-sub stores, etc. in accordance with the present invention. Each such store can offer its own subset of product components to allow others to create customized products for purchase and/or for presentation and sale on their own online store.

More particularly, the user interface can enable a first user to select a first subset of the product components to present on a first online store. A second user can be enabled to select a second subset of product components from the product components presented on said first online store. The second user can be enabled to create an online sub-store to allow others to create customized products using the second subset of components.

The user interface can enable users to link their stores and sub-stores to social media sites. Similarly, the interface can enable users to embed their sub-stores in web sites other than a primary web site for the online sub-store. The user interface can also enable the creator of a first store to configure payment structures for sub-stores created by others and associated with the first store. The creators of stores and sub-stores can be compensated by an operator of the computer system based on sales of their respective customized products and sub-customized products.

In an illustrated embodiment, the products comprise clothing. In this embodiment, the user interface provides a selection of models (e.g., photos of men and women) that users can select to provide representations of their customized clothing being worn. In the context of building an online store, the models are referred to as “store components.” Users building an online store can choose some or all of the available models to appear on their store. The user interface can also provide a fabric meter indicative of an amount of fabric remaining in inventory for manufacturing a customized product ordered from an online store.

A method is provided for selling customized products and creating customized online stores. In accordance with the method, a network accessible computer system is provided and has a database associated therewith. First users are enabled to access the computer system via the network in order to customize products and/or choose a subset of product components offered via the computer system. Data is stored in the database indicative of at least one of customized products designed and subsets of product components chosen by the first users. These users are offered a choice of (i) purchasing their customized products and/or (ii) creating online stores, each offering a respective one of said subsets of product components to allow others to customize products using the respective subset of product components. Data representative of online stores created is stored in the database. The online stores can be accessed by others via the network for the design and purchase of the customized products.

Second users can be enabled to customize products offered via the computer system as well as via the online stores to create sub-customized products. Data is then stored in the database indicative of the sub-customized products created by the second users. The second users can then be offered a choice of (i) purchasing their sub-customized products and (ii) creating online sub-stores to offer and sell their sub-customized products to others. Data is stored in the database representative of online sub-stores created. The online sub-stores are allowed to be accessed by others via the network for the purchase of the sub-customized products.

Additional users can be enabled to customize products offered via the computer system and the online stores as well as via the online sub-stores to create additional sub-customized products. Data is stored in the database indicative of additional sub-customized products created by the additional users. The additional users can then be offered a choice of (i) purchasing their additional sub-customized products and (ii) creating additional online sub-stores to offer and sell their additional sub-customized products to others. Data is stored in the database representative of additional online sub-stores created. The additional online sub-stores are allowed to be accessed by others via the network for the purchase of the additional sub-customized products.

The creator of an online store or sub-store is enabled to configure payment structures for sub-stores created by others and associated with that online store or sub-store. First, second and additional users are enabled to link their stores and sub-stores to social media sites. First, second and additional users are also enabled to embed their stores and sub-stores in different web sites. The creators of stores and sub-stores can be compensated by an operator of the computer system based on sales of their respective customized products and sub-customized products.

Methods are also provided for selling customized products and creating customized online stores in which a network accessible computer system having an associated database is provided, where the database includes a library of components for use in customizing products. First users are enabled to access the computer system via the network to select a subset of components from the library. Data is stored in the database indicative of the subset of components. The first users can create online stores offering products together with the subset of components for use in customizing the products. Data is also stored in the database representative of the online stores. Others are allowed to access the online stores via the network and to customize the products using the subset of components. These customized products can then be purchased.

A second user can be enabled to select one or more sub-subsets of the components offered via an online store and/or included in the library of components offered via the computer system. Data is stored in the database indicative of the sub-subset(s) of components. The second user can create an online sub-store offering products and the sub-subset(s) of components for use in customizing products offered in the sub-store. Data is also stored in the database representative of online sub-stores created. Others are allowed to access the online sub-store via the network and to customize and purchase the products offered via the online sub-store using the sub-subset(s) of components. Other users can be permitted to create sub-sub-stores offering products and sub-sub-subsets of the components for use in customizing and purchasing products offered in the sub-sub-stores.

A computerized multi-tier, multi-channel sales system having an integrated accounting system is also provided. The accounting system includes means for tracking connections between stores and sub-stores that are part of the sales system. Means are provided for establishing and maintaining compensation structures for owners of the stores and sub-stores. Means are also provided for tracking and maintaining a history of sales made via the stores and sub-stores and earnings attributable to the owners as a result of the sales. The earnings attributable to the owners are based on the compensation structures.

### BRIEF DESCRIPTION OF THE DRAWINGS

FIG. 1 is a block diagram of a computer system in accordance with the invention.

FIG. 2 is a block diagram illustrating interactions between the CPU, Operators and Users of the present invention.

FIG. 3 is a screen shot showing an example interface for allowing Users to input information into the system database for Bases such as blank pre-produced garments.

FIG. 4 is a screen shot showing an example interface for allowing Users to input information into the system database for different Components that are used to customize Bases.

FIG. 5 is a screen shot showing an example interface for allowing Operators to input Patch information into the system database.

FIG. 6 is an example reference table that may be used to link the product management uploads for input to the database fields for various Models and the potential layout of a custom design that may be associated with the Model.

FIG. 7 is a schematic drawing illustrating the rendering of a final image for a custom design from different image layers.

FIG. 8 is a screen shot of a front end Store in accordance with a preferred embodiment, which has a grid of Products and systems for filtering Products.

FIG. 9 is a screen shot of a Product Detail Page in accordance with a preferred embodiment of the invention.

FIG. 10 is a screen shot showing an example of the primary steps for customization in which a Customer chooses a general clothing Category Type and then narrows in on a Base garment type.

FIG. 11 is a screen shot that shows the color options available for a Base garment.

FIG. 12 is a screen shot showing a Fabric tab in which the User can select Fabrics as well as the location of Appliqué Patches on a custom Base garment.

FIG. 13 is a screen shot of a screen provided to allow the User to review a completed design.

FIG. 14 is a screen shot showing a graphical interface that allows Users to manage and alter their custom Sub-Store settings and preferences, known as the Store Owner Controls.

FIG. 15 is a screen shot illustrating how a User can build a custom workshop (Sub-Customizer) including choosing bases, garments and colors.

FIG. 16 is a screen shot illustrating how a User can build a custom workshop (Sub-Customizer) including choosing fabric and textile categories.

FIG. 17 is a screen shot illustrating how a User can build a custom workshop (Sub-Customizer) including choosing models on which apparel items can be displayed.

FIG. 18 is a screen shot illustrating how a User can test the design of his/her Sub-Customizer.

FIG. 19 is a screen shot showing how Store Owners can view their sales and other pertinent information concerning custom Sub-Stores they have set up using the system of the present invention.

FIG. 20 is a screen shot showing how a Store Owner can edit the layout of a Sub-Store and/or Sub-Customizer.

FIG. 21 shows a central dashboard that controls the Order Management process in accordance with the invention.

FIG. 22 is a screen shot illustrating a Base Purchase Order (“PO”) list.

FIG. 23 is a screen shot showing an example of a Purchase Order that an Operator has generated from Orders on the Base PO list.

FIG. 24 is a screen shot illustrating a list of Orders that an Operator can add to a Production Ticket in accordance with the invention.

FIG. 25 is a screen shot showing an open Production Ticket to which a Manufacturer can refer for details about each item such as Priority, Base, Color, Size, Fabrics and Patches.

FIG. 26 is a screen shot that demonstrates in greater detail the information of each item needed for the Manufacturer.

FIG. 27 is a screen shot illustrating an open Production Ticket.

FIG. 28 is a screen shot illustrating a list of all open Production Tickets.

FIG. 29 is a screen shot showing a Shipping Label list.

FIG. 30 is a screen shot showing a Pick Up list.

FIG. 31 is a screen shot showing an example “Your order has shipped” email.

FIG. 32 is a screen shot showing an example “Your order is ready for pickup” email.

FIG. 33 is a screen shot showing the delays with purchasing base garments.

FIG. 34 is a screen shot showing production errors.

FIG. 35 is a screen shot showing lost packages.

FIG. 36 is a screen shot showing invoice details.

FIG. 37 is a screen shot showing Customer details.

FIG. 38 is screen shot of a preferred embodiment for the format of a CSV file for inputting customer and Order data to the Order Management system.

FIG. 39 is a screen shot of a preferred embodiment showing the method of uploading images for Models, Bases, and Patches for a particular Base on a specific Model, see FIG. 6 for an alternate embodiment.

FIG. 40 is a screen shot of a preferred embodiment of a Fabric Page which displays the Components (Fabrics) offered in the Customizer

FIG. 41 is a screen shot of a preferred embodiment of a Fabric Detail Page which displays details of a specific Component (Fabric)

FIG. 42 is a screen shot of a preferred embodiment of a Sell Page which displays a Logo and name for each User's Sub-Store that each link to a User's Sub-Store

FIG. 43 is a screen shot of a preferred embodiment to allow a User to register and create a login account

FIG. 44 is a screen shot of a preferred embodiment for Users to learn about creating their Stores and enter their payment information for receiving their Sub-Store Commissions

FIG. 45 is a screen shot of a preferred embodiment for Users to choose their Sub-Store name and Community and upload their Sub-Store logo

FIG. 46 is a screen shot of preferred embodiment of the Store Owner Controls, see FIG. 14

FIG. 47 is a preferred embodiment of one tab of the Store Owner Controls, showing where Store Owners can choose colors and images to customize the look and feel of their Sub-Stores and Sub-Customizers, see FIG. 20.

FIG. 48 is a preferred embodiment of how Store Owners selects Fabric Components to add to their Sub-Customizers and Sub-Stores, see FIG. 16.

FIG. 49 is an Order Tracker for Customers who pick up their Orders directly from a production facility instead of having them shipped, see FIG. 19.

FIG. 50 is a preferred embodiment of a notification email sent by the Company to Store Owners when they receive Orders from their Stores.

FIG. 51 is a screen shot of a preferred embodiment of a Sub-Store.

FIG. 52 is a screen shot of a preferred embodiment of a Sub-Customizer.

FIG. 53 is a screen shot of a preferred embodiment of a Sub-Store's Fabric Page.

### DETAILED DESCRIPTION OF THE INVENTION

Although the invention is described in connection with a preferred embodiment, it will be appreciated that numerous other embodiments and implementations are possible as will be apparent to those skilled in the art.

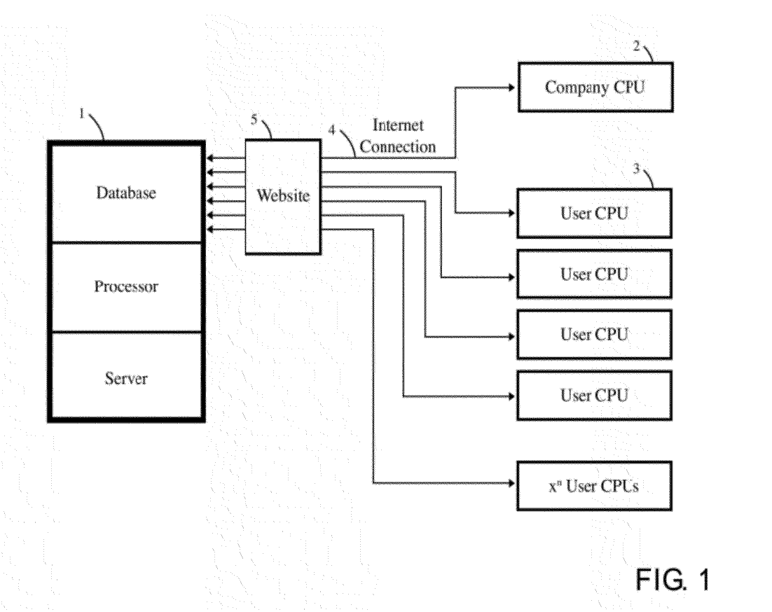

FIG. 1 is a block diagram illustrating the network-based nature of the invention. A central Server and Processor CPU (1) stores all system data in an associated database. The managing Company (2) and all Users (3) of the system interact with the database via an Internet connection (4) and a central Company Website (5). Users can sign up for password protected login accounts to view and manage controls for their own Sub-Stores and Sub-Customizers. The Company can login to the website to view and manage controls for Accounting, Users, Order and Product Management systems which are all informed by the database. This online interface can be accessed by any personal computer or electronic device that connects to and displays from the Internet or similar communications network.

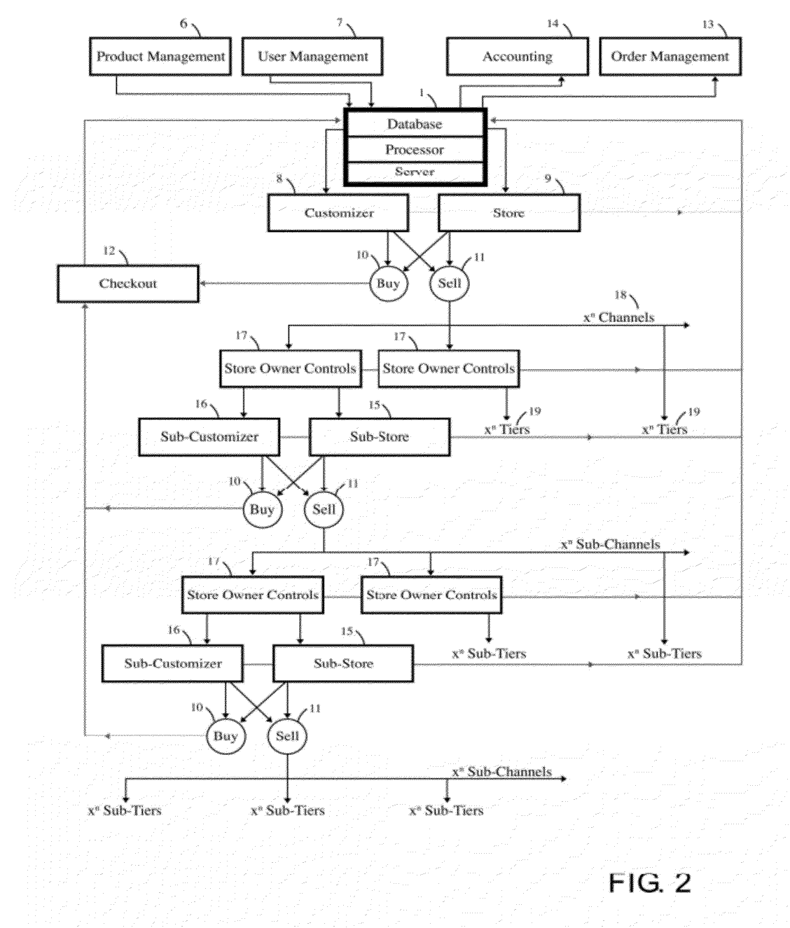

FIG. 2 shows the centralized Database supported by its Server and Processor (1) with inputs and outputs stemming from interaction with Company “Operators” (backend) and Website Users (front end). The two main inputs from Operators are “Product Management” (6) and “User Management” (7). In Product Management, Operators input data regarding the Components that Users can combine to create a finished Product. In User Management, Operators dictate and control each individual User's access, privileges and rewards.

The database generates an overarching front end Customizer (8) where Users can select different features to personalize and customize pre-produced Bases and add them as finished Products to a site wide Store (9). From the Customizer, Users can save their designs to their individual login-protected accounts to revisit later, they can purchase their designs, they can sell their custom designs, and/or they can share their designs through a custom link.

In the Store, Users may view, share, save, customize, buy (10) and sell (11) existing finished Products. Users can view all finished Products, including those created by other Users as well as Operators. In order to facilitate such viewing, the database sorts through fields the Operator inputted in Product Management to generate filters for Users to easily navigate and search the finished Products in the Store. Like in the Customizer, in the Store Users may also share the images and links to finished Products with others directly through existing social media networking sites (such as Facebook® and Twitter®).

Users may choose to customize a finished Product by altering the Components that make up the finished Product in the Customizer.

When Users purchase Products (from either a Store or Customizer) they are redirected to a shopping cart and “Checkout” system (12) which transfers the Order information through the database to the Order Management system (13) and Accounting system (14). In the Order Management system, the Operators can systematically create reports to purchase Bases, manufacture finished Products, and ship and track “Orders” (purchases of Products) to Customers. In the Accounting system, Operators can systematically create reports to accurately and promptly pay Suppliers and Manufacturers through database driven functionality. Operators can also generate sales reports from specific Channels and time periods. In addition, Users can sell their own designed finished Products (or other User's finished Products) by activating and personalizing their own Sub-Stores (15) and/or Sub-Customizers (16) through Store Owner Controls (17), consequently deeming them “Store Owners.” Store creation and development information returns to the database as an input from Store Owners to cycle back out to the front end for other Users to see and explore.

Store Owners can gain emotional and financial rewards by marketing their Sub-Stores, Sub-Customizers and customized finished Products. Each Store Owner becomes a Channel (18) through which the Company sells. Additionally, Users can select to sell on behalf of an existing Channel, creating another Tier (19) of Sub-Stores (15) and Sub-Customizers. The invention provides a unified software and database system that combines virtually unlimited Component entry in Product Management with a virtually unlimited Multi-Channel and virtually unlimited Multi-Tier selling of custom finished Products with a central payment Checkout, Order Management and fulfillment processor and an Accounting reporting system.

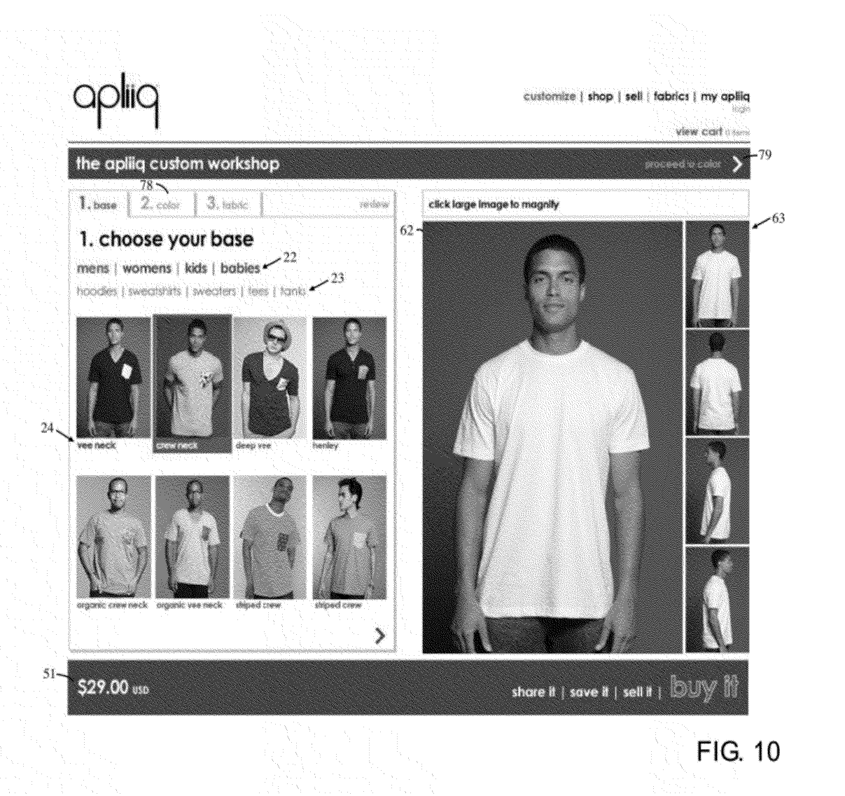

Those skilled in the art will appreciate that the inventive concept described above can be applied to many fields of interest, including, for example, clothing, shoes, home goods such as wallpaper, curtains, blinds, sheets, blankets, pillows and throws, hard goods such as furniture, kitchen cabinets, bathroom accessories, sculpture, artwork, stationary, greeting cards, toys, bicycles, motorcycles, automobiles and the like, and virtually any other manufactured item that lends itself to customization. One such field, described herein for purposes of illustration but not intended to be limiting in any way, is the custom “Appliqué” (ornamental or functional application of pieces of fabric, trim, or other materials that are sewn, stuck, glued, attached, or otherwise fixed onto a larger piece of fabric) apparel field, in which clothing and other items are customized with User selected fabric swatches. Such an implementation is illustrated in FIGS. 10-20 which show an embodiment of the invention as a custom Product generator which includes the ability for Users to set up Sub-Stores and Sub-Customizers to sell custom goods through a four step process (as in FIGS. 10-13) and personalize the layout and design and monitor the success of their Sub-Stores and Sub-Customizers through Store Owner Controls. Such a Sub-Store can be used as a means to generate revenue for any entity that can relate to custom Appliqué apparel such as an individual, team, school, non-profit organization, enterprise, or the like. Furthermore, it will be apparent to one skilled in the art that this same methodology can be applied to any customizable Product including, without limitation, clothing, sporting equipment, furniture, accessories, footwear, household goods, pet Products, packaging, stationary, office Products, food Products, books, music, cars, home furnishings, furniture, home improvement projects, homes, light fixtures, boats, airplanes, bicycles, shoes, sneakers, jewelry, scarves, belts, hats, flags, curtains, linens, sails and the like.

Real time (or Just-in-Time) manufacturing is important for this virtual system to function. In the case of the garment industry, rather than creating inventory to sell through stores and other retail venues, Products are made right after the Customer orders them. The computerized software system and database of the present invention is unique in that core Components of each Product can be managed and combined in different ways by the online Customer. In this manner, the design and purchasing process is tied to a practical manufacturing system that breaks from the normal Production and inventory structures in place and allows for quick Production turnaround for each individual Order.

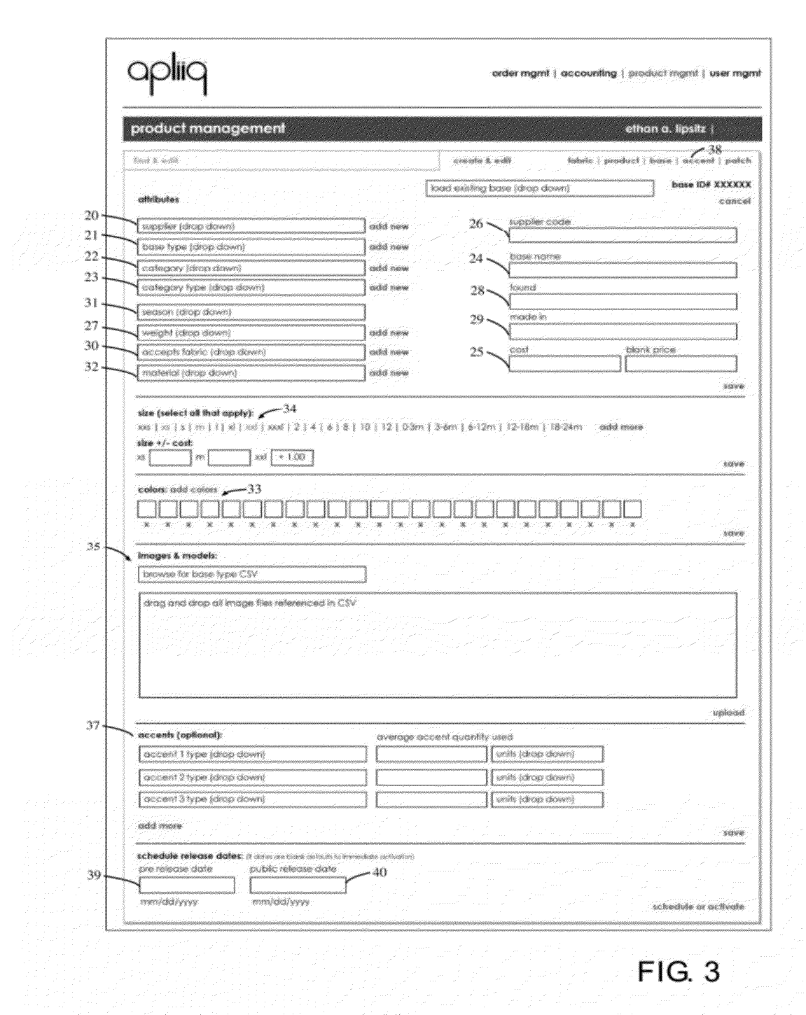

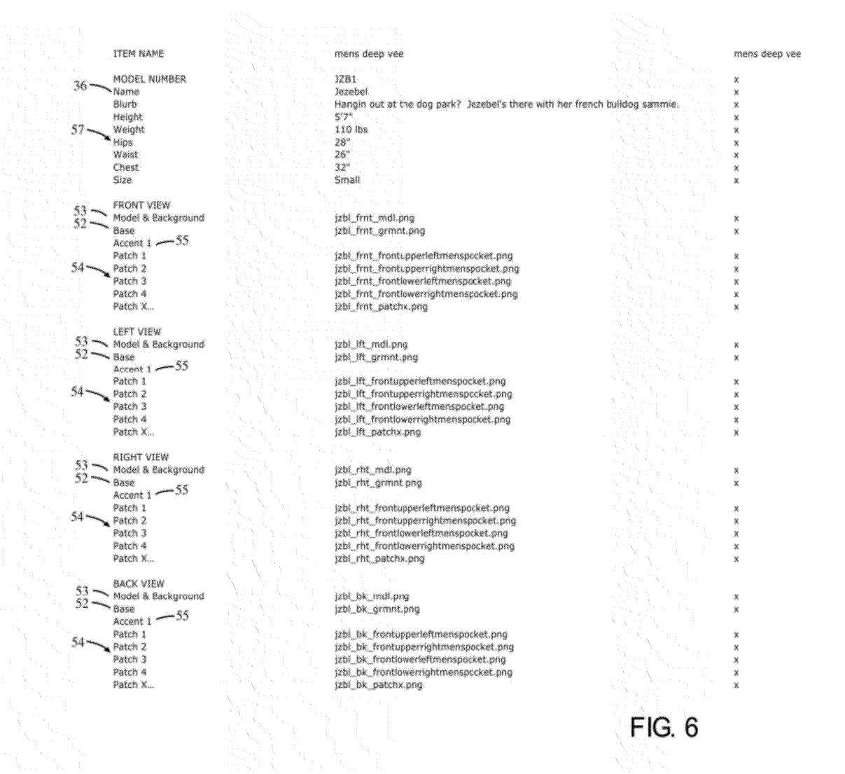

In the illustrated embodiment, there are five Components that require data from the Company in Order for the software system and database to produce the front end User interface and the Company's Order Management and Accounting system. FIG. 3 shows one point of access to input information into the database for Bases, (blank pre-produced garments available for purchase from external Suppliers which Users can personalize and customize). In the case of a Base garment, the Operator would select the Supplier (20) of the garment, the Base Type (21) (e.g., apparel), the Category (22) (e.g., men's), the Category type (23) (e.g., t-shirt), and name the item (24) (e.g., V-Neck T-Shirt). Other drop downs and fields specify information regarding the Cost to purchase the Base from the Supplier (25), the “Supplier Code” (26) (the alphanumeric reference for the Base from the Supplier), the Price to charge the Customer for the Base (this price increases as the User customizes the Base), the Weight of the Base (27) (used later in Order Management to generate shipping labels), the Location where the Base was found (28), the Origin where the Base was created (29), the Type of Fabric the Base accepts (30) (i.e., thick or thin) and several fields used to filter and differentiate the final Products in the front end Shop navigation (see FIG. 6) such as, the Season(s) that best relates to the Base (31), the Material of the Base (32), the Colors available in that particular style (33) and the Sizes (34).

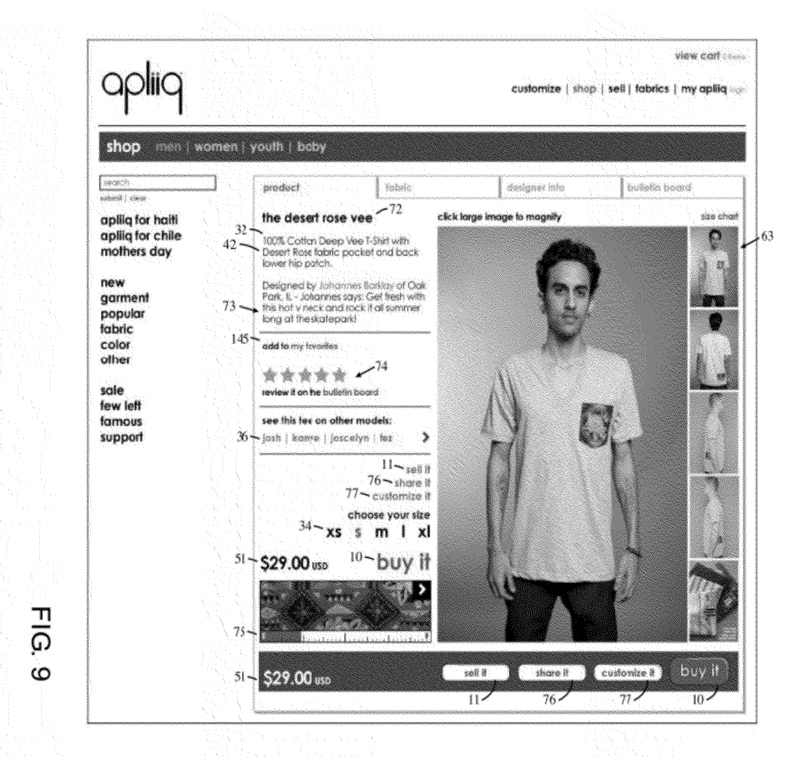

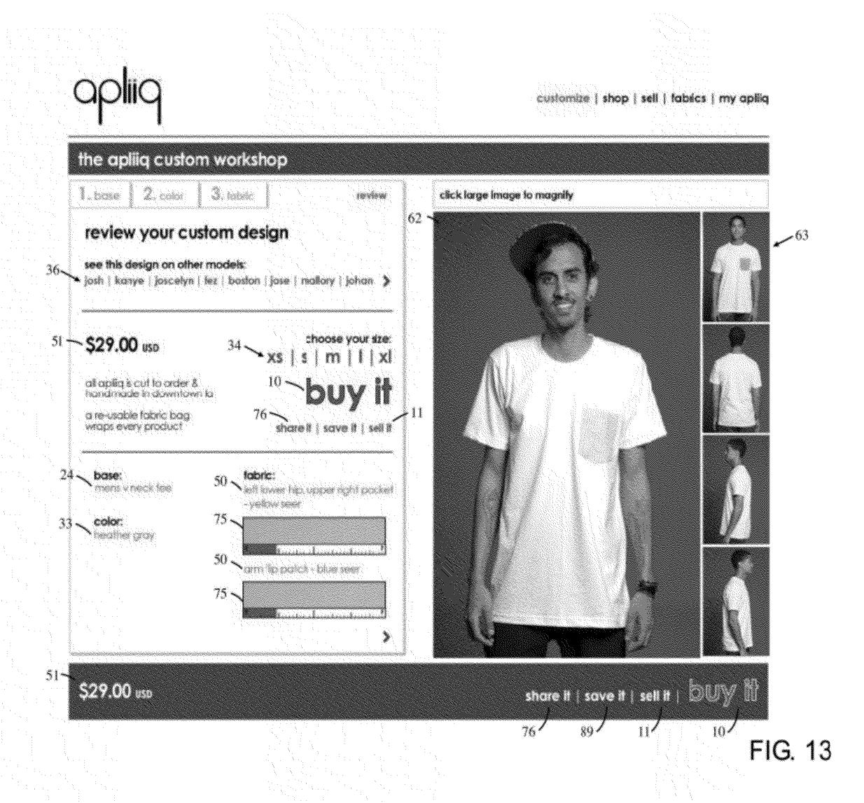

For each Base, the Operator will upload a file, such as a comma separated value (CSV) file, that references images and information of the Models (35) wearing the Base that will be displayed in the Customizer (as seen in FIG. 13 where a User may select a Model's name (36) to see his/her design being worn by a desired Model) and then throughout the Product Detail Pages (as in FIG. 9 (36)). FIG. 6 illustrates an example of code that may be used to identify various Models and the layout of a custom design that may be associated with the Model. This information includes the name of the Model (36), the body measurements of the Model (57), and custom layout information (52), (53) and (54) to enable a representation of the Model in the custom garment to be generated and displayed on a User's monitor.

In the “Accent” section (37) of FIG. 3, the Operator selects if the Base has an Accent and specifies the type of Accent. For example, a hooded sweatshirt has a drawstring Accent available for customization. In the Create & Edit Accent tab (38) shown in the top right corner of FIG. 3, the Operator can specify which type of accents exist and upload corresponding photographs to the database for display on the front end. Finally, the Operator can schedule a date for the Base to appear on the front end for only those Users with login- protected accounts (Pre-Release date) (39) and/or a Public Release date (40) for the Base to be released to all Users regardless of account status, or the Operator can select to make the Base active on the front end immediately.

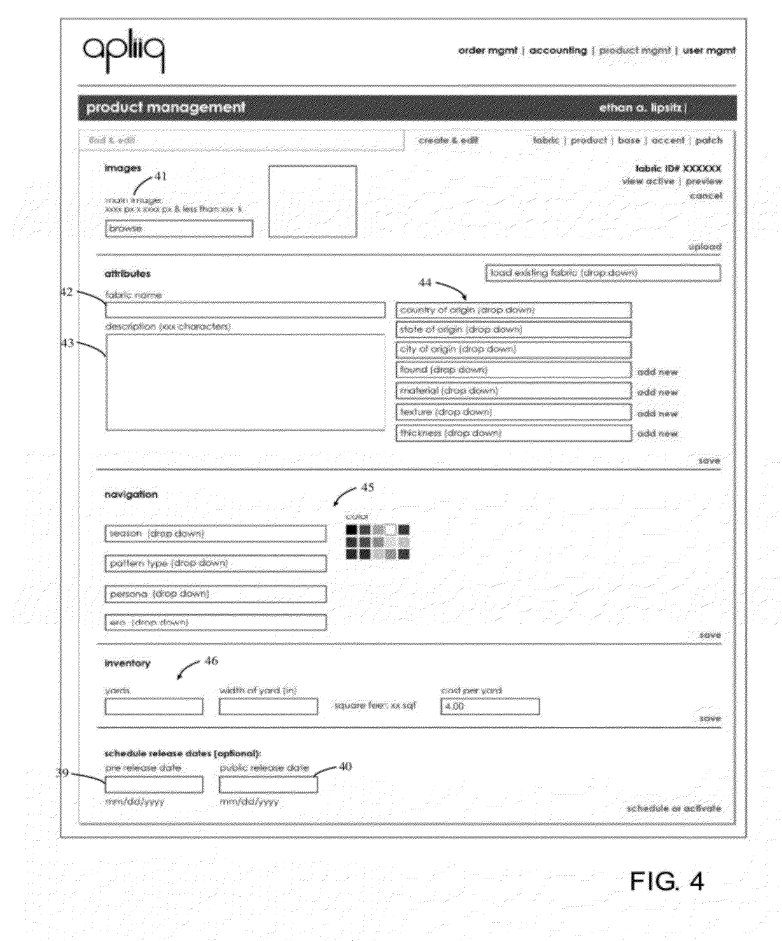

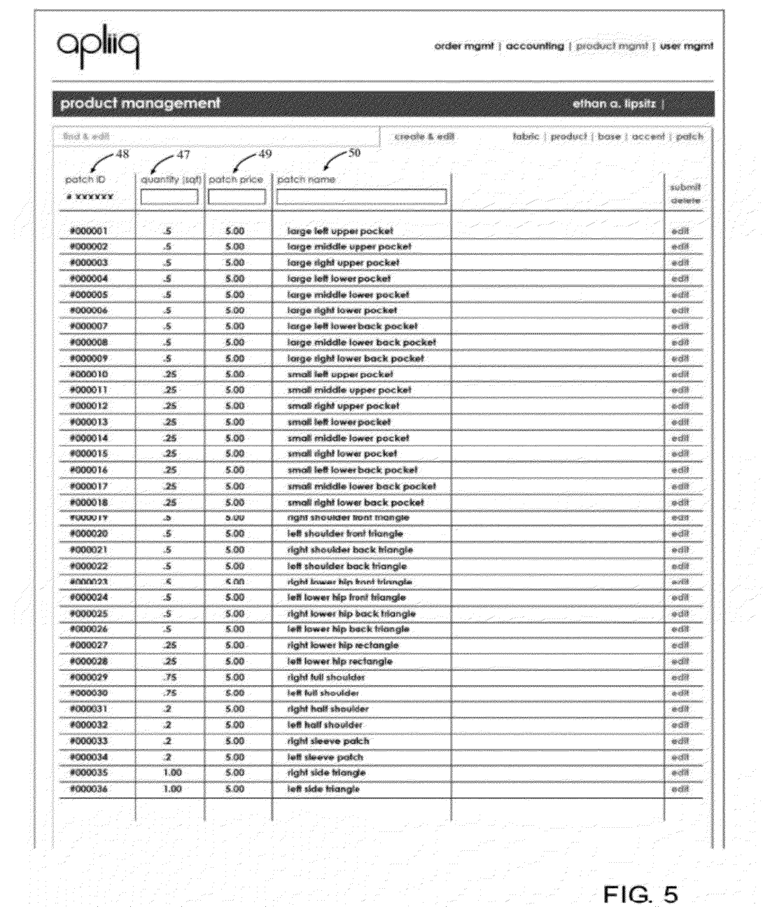

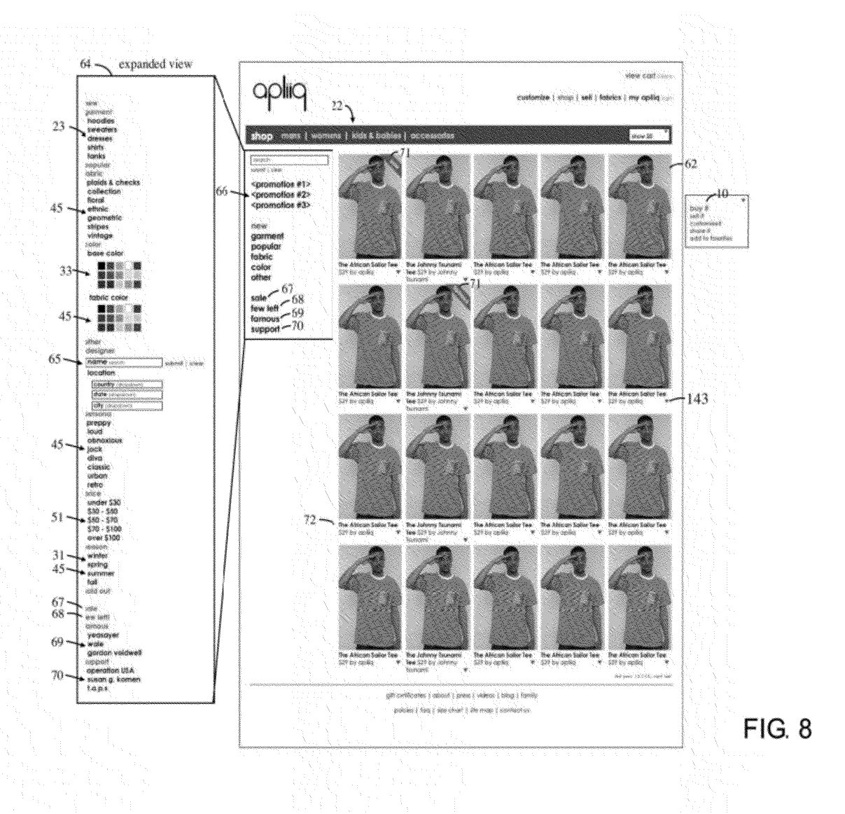

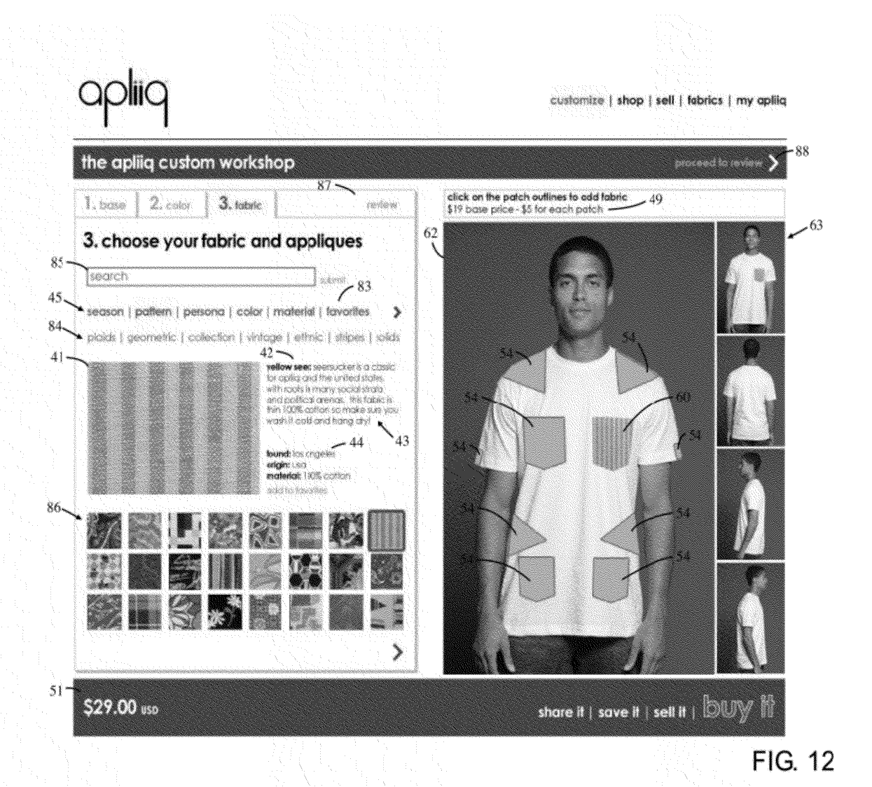

FIG. 4 shows another area to input data for different Components (in the illustrated embodiment Fabric) used for customization of Bases. The Operator can upload an image of the Fabric (41), name the Fabric (42), and write a description of the Fabric (43), all of which displays on the front end in the Customizer (see FIG. 12) and the Fabric detail pages. Additionally, there are a couple of dropdown choices in FIG. 4, which Users utilize in the navigation of the Store (see FIG. 8) and in the navigation of the Customizer (see FIG. 10), such as Origin, Found, Material, Texture, Thickness (44) Season, Pattern, Persona, Era and Color (45). The Thickness field determines if a Fabric can be applied to certain Bases, as specified in Base creation (FIG. 3 (30)). The inventory section (46) allows the Operator to input a quantity of yards and the width of each yard and the cost per yard. The system can then calculate the Quantity in square feet available and deducts from this amount when a User purchases a Product with the Fabric. The amount of Fabric deducted depends on the quantity used in the Patch the User selects (see FIG. 5 (47)). The Operator can also set a date for the Fabric to appear on the front end for only those Users with login-protected accounts (Pre-Release date (39)), and/or schedule a Public Release date (40) for the Fabric to be released to all Users regardless of account status, or the Operator can select to make the Base active on the front end immediately.

FIG. 5 is a place to input another level of customization into the database, in the case of the illustrated embodiment, for Patch information. Each Patch receives a unique ID (48) and has various fields associated with it such as: Quantity in square feet (47), Patch Price (49) and Patch Name (50). The Operator can specify the Quantity of square feet needed for the Production of the Patch, which is deducted from the total Quantity of Fabric when a Customer purchases a Product with the Patch. When a User selects a Patch in the Customizer (see FIG. 12 (49)), the Patch Price is the amount added to the Price of the Base. For example, if a plain t-shirt costs $24, and the User selects a Patch that costs $5, the total cost of the Product is $29 (see FIG. 10 (51)). The Patch Name (FIG. 13 (50)) denotes the location and shape of the Patch. Each Patch can be used on multiple Bases, and individual image layers are uploaded and referenced to the database for each Patch that exists on a Base in each view of the Base in, e.g., a CSV file (FIG. 6) as part of Create & Edit Base (See FIG. 3 (35)).

In the illustrated embodiment, the Company employs a multi-step process to generate the inputs needed for the computerized software and database system to process and generate a custom Product. In order to upload images of the Bases, the Company first photographs Models wearing the Bases in a neutral color (such as white) in several different angles, or views. For each view, the Company uses a digital photograph editing tool to separate the photograph and save it as two separate images: 1) the “Base Image” (52) and 2) the “Model and Background Image” (53). Next, for each view, the Company uses a digital photograph-editing tool to digitally draw Patch shapes (54) in their proper location on the Base. Each Patch drawing is saved as an image without any background in the same dimensions and corresponding location to the Base Image and the Model and Background Image. Also, if applicable, the Company uses a digital photograph-editing tool to digitally draw Accent shapes (55) (such as a hoody drawstring) in their proper location on the Base.

Subsequently, each Accent drawing is saved as an image without any background in the same dimensions and corresponding location to the Base Image and the Model and Background Image. The Company also photographs each Component (in this case Fabric (41) and Accent (56)) at the same distance and dimensions at which the Base was photographed on the Model. Each Component is saved as its own image file in the same dimensions as the Base Image and the Model and Background Image. Finally, the Company creates images of each Base Color (33) in the same dimensions as the Base Image and the Model and Background Image.

The Company inputs the images described above in the Product Management screens (See FIGS. 3-6). The Company uploads Fabric images (41) in the Create & Edit Fabric screen (FIG. 4) along with their corresponding details. Base, Patch and Color images are uploaded in the Create & Edit Base (FIG. 3) screen alongside an appropriate file, such as a CSV file (FIG. 6) that references each image file name and associates it with a field in the database. In FIG. 6, the Operator adds additional information about each Model such as name (36), weight, height, other measurements, as well as description, and interests (57). Each such file is specific for every Base, and there can be multiple Models on a single file. For every Model, the file saves the uploaded file names for all associated Model and Background Images (53), Base Images (52), Patch images (54) and Accent images (55) and adds them to the database.

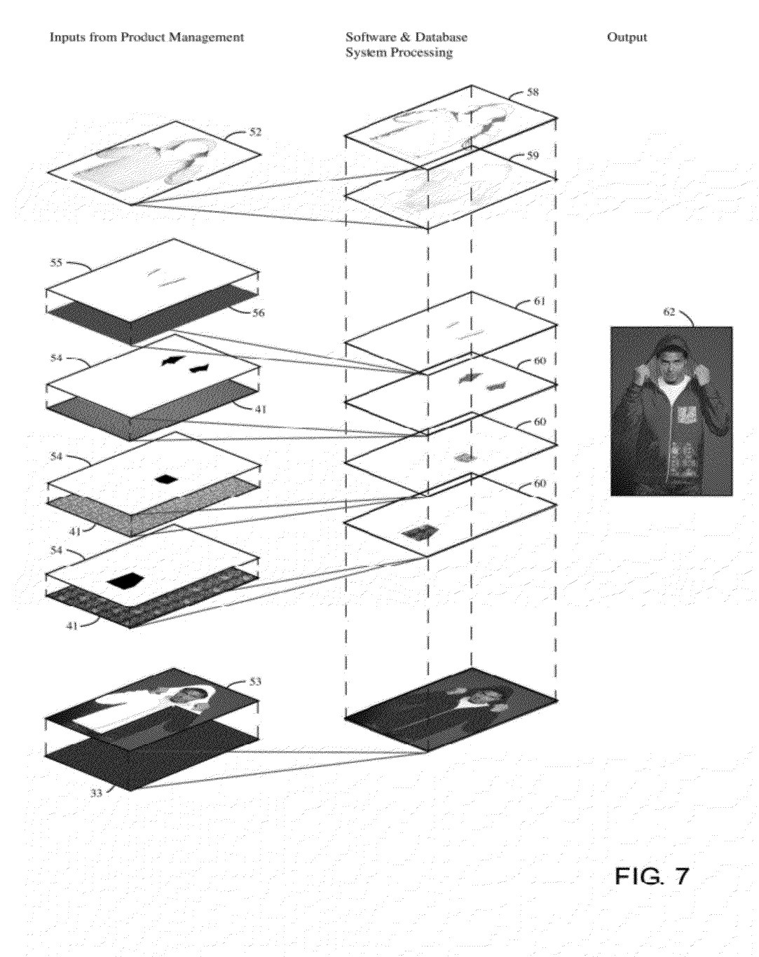

FIG. 7 illustrates how the software and database system renders a Product in the Customizer through the combination and layering of the uploaded image inputs described above. The software and database system completes a number of tasks to turn the image Inputs from Product Management into elements of the finished Product rendering. The first task is the recognition and separation of the dark shadows and light highlights in the Base Image. These features are turned into semi-transparent layers that give life-like, realistic shadows (58) and highlight contours (59) to the rendering. The software and database system also combines the Patch (54) or Accent shapes (55) that the User chooses with a specified Color (56) or Fabric image (41). The result of this combination is a Patch or Accent shape that is filled with the specified Color or Fabric, a Patch layer (60) and Accent layer (61) respectively.

The computerized software and database system of the invention displays the Fabric and Color shapes or Patches (60 & 61) beneath the semi-transparent highlight (59) and shadow (58) layers. In this manner, the highlights and shadows are visible on the entire Base, including the Patches and Accents areas. Beneath the highlight, shadow, Patch, and Accent layers are the bottom two layers which consist of the Model and Background Image (53) and the chosen Base Color Image (33). The ordering of the layers allows certain pieces of information to show through where others are hidden, in the end, creating a realistic rendering of a Product (62) that has never been physically created, nor photographed on a Model. This allows the User to see each Fabric rendered on each Patch in a multitude of permutations and similarly, the User can see each Base in a variety of different colors while maintaining the Fabric Patch combinations. In this way, the User has the ability to design and preview an unlimited number of life-like Products nearly instantly- without the Company incurring the costly and time-consuming process of buying wholesale materials, manufacturing, photographing and/or shipping the custom designed Product.

When the User is satisfied with his/her custom design, he/she may proceed to save, sell, share or purchase the designed Product. At any of these steps, the computerized software and database system of the invention manipulates and combines the layers, then saves them together as one image (62). Then the system can create a Product Detail Page (FIG. 9) with information from the Components that compose the Product. For example, if a User designed a red t-shirt with a blue and white striped fabric pocket Patch, the Product Detail Page would display all of the corresponding information about the material of the t-shirt (32), the name of the fabric (42) and the cost of the finished Product (51), among other information (See FIG. 9). In addition to the Product Detail Page, the Customizer, Checkout, and the Order Management's Production Ticket each display four views of every Product (FIG. 9 (63)). This means these layers are combined four times for four different perspectives for every Product for every different Model and are saved and rendered throughout many areas of the website. The single combined image remains segmented as Components in the computerized software and database system and can be rearranged and manipulated by the User at any point throughout the website. If the User wishes to change some feature of a finished Product, the User simply clicks “customize it,” which redirects the User to the Customizer where all the layers of the Product appear and the User can manipulate and save the layers as a new Product.

FIG. 8 is an example of a front end Store, which has a grid of Products and two systems for filtering Products. The grey header near the top of the page displays the first level of filtration with a basic Category separation between Men, Women, Kids & Babies, Accessories (22), which the Operator entered as an input in the backend Product Management section of the site (FIG. 3 (22)). Similarly, the left side navigation (64) is a more extensive filtration system that works in conjunction with the top Category filter. The left side navigation allows users to filter by Category Type (23), Color of Base (33), Color of Fabric (45), Persona (45), Era (45), Fabric Pattern (45), Price (51), Season of Base (31), Season of Fabric (45), Designer (65), and any other input that is added in the Product Management section. The Company can also input “Promotions,” (a group of Products that all relate to each other and/or a common theme or marketing campaign) and the software and database portions of the system generates direct links to each Promotion (66) page that show up in the top of the left navigation bar. The Operator can select and assign specific Products to different Promotions and the Promotion pages automatically generate and display those Products which have been assigned to the Promotion.

For example, the Company may choose to create a Promotion for a holiday such as Christmas. The Operator can select and assign all Fabrics that relate to Christmas, (such as red and green Fabrics, or Fabrics with Santa Claus, or Fabrics with winter snow flake imagery) to the Promotion. In turn, all Products that have those Fabrics will appear in the Christmas Promotional page. For each Promotion, the Company may also upload a themed banner image to display above the Products in the Promotion along with some descriptive text.

“Sale” (67) is another filter that displays any Product with a price reduction (which the Operator determines in the backend of Product Management or in the Site Management by creating Promotions and discounts.) “Few Left” (68) is a filter that sorts Products based on low Quantities of Fabric remaining. As mentioned above, the Operator inputs the initial Quantity of Fabric in the Product Management section. Similarly, the “Famous” (69) and “Support” (70) buttons filter Products that derive from celebrities or charities, respectively. Items that fall in the categories of Few Left, Famous, Support, Sale and other categories created by the Company are given “Ribbons” (71) which are small graphic tags applied to the thumbnail images in the Store. The tags denote the special status of the Product and act as a marketing tool to highlight specific Products when browsing and filtering through a Store. When Users select items from either filter the Product results narrow down to match the criteria selected.

The User can select from several options in the Store page, including a “Buy it” button (10). A User can also click on a Product image (62) or Name (72) to see the Product Detail Page (See FIG. 9). The Product Detail Page lists the description (73) input by the Designer (65), the Material composition (32) generated from the database, a rating system (74), four views of the Product at different zoom levels (63), as well as the option to click on a Model's name (36) to see the Product on that Model, the dynamic price (51) composed of all Component prices (49) and price reduction or inflation factors, and a Fabric Meter (75) which is a visual way of displaying the Quantity of Fabric that remains. In the illustrated embodiment, the User can perform four main actions, namely, Sell it (11), “Share” it (76), Customize it (77), and Buy it (10), as explained below. The option to Sell it (11) allows the User to become a Store Owner prompting him/her to login or register for his/her own account and own Sub-Store and Sub-Customizer. Once logged in, the Product can be named and described by the Store Owner and is saved to his/her Sub-Store and available for purchase by other Users. The User can also select Share it (76) which saves the designed Product and provides a link to copy or directly insert to a User's personal social media networking site such as Facebook® or Twitter®. By clicking Customize it (77), the computerized software and database system redirect the User to the Customizer which loads all the Components of the Product. The User can then change any element. Finally, the User can select Buy it (10) to add the Product to a shopping cart and continue shopping or go through a Checkout (12) to complete his/her purchase, thereby turning a User into a Customer. If a Size (34) isn't selected prior to clicking Buy it, a pop up screen can display and prompt the User to choose his/her Size.

In the illustrated embodiment, the Customer can customize clothing by selecting various database fields or variables including: Base garments, Base garment Colors, the Fabrics available for custom application, the placement of each Fabric and the Models that display, wear, and stylize the custom clothes. The customization process shown in FIGS. 10-13 illustrates the front end User experience of designing a custom Appliqué garment.

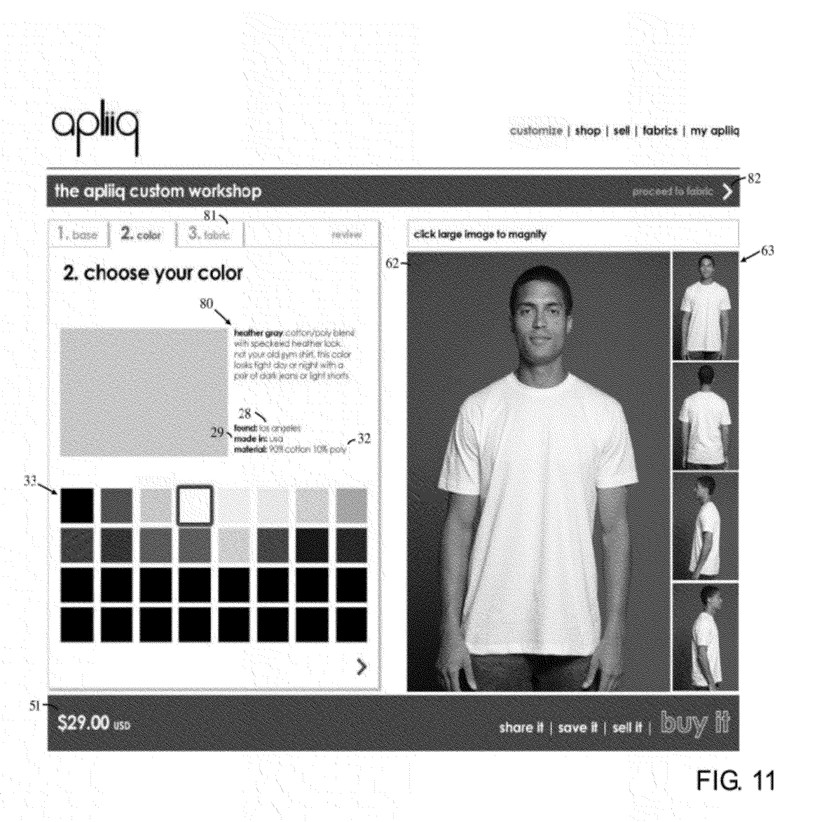

FIG. 10 displays an example of the primary steps for customization in which a Customer chooses his/her general clothing Category Type (Men's or Women's) (22) and then narrows in on a Base garment type (23) (hoody, sweatshirt, sweater, tee shirt, tank top, etc.). By default, the system can select a Base garment when the Customer enters the Customizer, however the Customer can select from any available Base garment by navigating the available options. Once a Customer selects a Base garment type, a variety of subcategory options can appear and a User can look through the options and select a more specific type of tee shirt (24)—such as a V-neck, a crewneck, a deep V-neck, a Henley, a button down, etc. When the User clicks to select a Base garment, it can appear in a large photographic image rendering (62) worn by a Model on the right side of the screen. Simultaneously, a plurality (e.g., four) smaller thumbnail photographic image renderings of different views of the garment on the Model can appear alongside the main large image (63). Each thumbnail enlarges to the main image when a User selects it. When a Customer is satisfied with the Base selection, he/she can click the “color” tab (78) or the “proceed to color” button (79) to move to the next screen for further customization as shown in FIG. 11.

FIG. 11 displays the color options available for the Base garment that the Customer selected on the previous tab. The Customer can click on any Color (33) to view a larger image with a name and description of the Color (80), the Material makeup of the Base garment (32) and the Origin of the Base (29) (all database fields inputted by the Operator as demonstrated in Product Management above). Also when a User selects a Color, the images of the Base garment on the Model change to that selected Color. For example, if a user selects the Color red, the tee shirt turns red in the main image as well as in the thumbnail images. Through a series of layered images that separate the main image and allow just the Base garment Color to change while retaining the shape and position of the Model as well as the dark and light highlights on the garment itself (as described above in FIG. 7), the photographic images realistically render the Color selected (62). When the Customer decides on a Color, he/she can then select the “fabric” tab (81) or the “proceed to fabric” button (82) to move to the next step in the Appliqué customization process.

FIG. 12 shows a Fabric tab in which the User can select which Fabrics they want as well as the location of Appliqué Patches (54) on his/her custom Base garment. A series of navigation options display the Fabric offerings by Pattern, Material, Season, Persona, Color (45) or a list of saved favorites (83) that the User has previously selected and saved in his/her personal login-protected account area. Each category also has subcategory sections to help navigate for Fabrics (84). For example, if the User clicks Season category, the subcategory displays further subdivisions for Summer, Winter, Spring and Fall Fabrics, as previously determined by the Operator in Product Management. The User can also use the general search box (85) to find a Fabric that relates to his/her specific search term. When a User selects a Fabric thumbnail image (86), it appears as a larger image (41) with a description (43) that includes the Fabric name (42), Origin (where it was created), Found (where it was purchased), the Material (44) and some general information about the Fabric. Outlines of available Appliqué Patches (54) display on the Base garment on the right side of the screen and when the User clicks on a Patch outline it fills with the selected Fabric (60). As Appliqué Patches are selected and deselected, the price of the custom garment (listed on the bottom left of the screen (51)) rises and falls accordingly. As mentioned above in Product Management (FIG. 4), the software system and database allow each Component Patch to have a different price (49) and show an increase in the total price of the Product when the User selects it. When a User selects a thumbnail image of the garment from a different perspective view (63), it populates the large main image (62) and the Appliqué Patch (54) options for the respective view of the Base garment appear for selection. The User can add, remove and change the Fabric in each Patch until satisfied with the design. Once the Customer is satisfied with their Fabric appliqués, he/she can select the “review” tab (87) or the “proceed to review” button (88).

The review screen (FIG. 13) displays the customized Product (62) in the five images (63) on the right of the screen. On the left, the User can choose to view their design on a different Model by selecting from the list of available Model names (36). Alternatively, the user can upload an image of him/herself or of other Models. This means the design of the Product and the customization will remain and only the Model will switch which encourages the User to see his/her design on a Model that relates to his/her style, skin tone, look, taste, or preferences. Users can also review their selections with each chosen option/variable listed under each section (Base, Color, Fabric). The Fabric section displays a small long image of each fabric with a meter beneath it to show the quantity of fabric left in stock (Fabric Meter) (75). As mentioned previously, depending on the quantity of Fabric remaining, the Fabric Meter displays an image of the remaining quantity such as different color and Quantity level just like a gas tank meter that displays a scale from full to empty. The Fabric Meter illustrates the limited nature of the fabric inventory and encourages the Customer to purchase his/her custom designed Product before the Fabric runs out. The Fabric Meter concept may also be used to show the Quantity of other Components such as Bases or Accents to show their limited nature. In this example, the middle of the left panel shows the Product price (51) and allows the Customer to select his/her Size (34) and Buy it (10), Sell it (11), or Share it (76), as described above. When the User selects “Save it” (89), he/she is prompted to add a name and description to the custom designed Product and then decides whether to save it to the main Store or to save it to his/her own personal login-protected account area to be revisited at a later point, or both. Also at any point throughout the customization process the Customer can click on any tab or step. There is no rigid order in which a customer must design his/her garment.

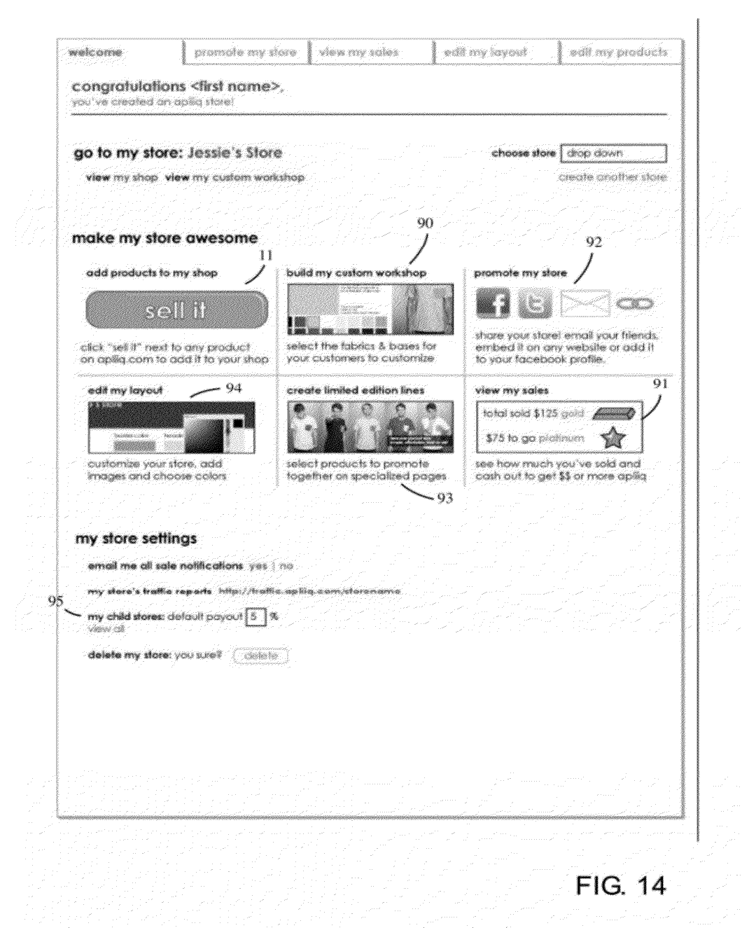

If a User clicks Sell it (11), registers for an account with the site and creates his/her own Sub-Store he/she is directed to his/her Store Owner Controls (17) as illustrated in FIGS. 2 and 14. At this point, the user is given the opportunity to add a Sub-Customizer (90) to his/her personal Sub-Store. Other controls in the Store Owner Controls include the ability to view all sales (91) through a personal Sub-Store, promote one's Sub-store with links and connections to social media sites (92), add Products to one's store (11), segment them to create specific Product lines (93) and edit the layout and colors of one's Sub-Store (94). The Store Owner also has Sub-Store settings to configure the payment structure for Sub-Stores that sell on his/her behalf (95). In addition, the meta tags chosen for the Product, Product line or Sub-Store will allow its automatic listing in search and directory features (64) of any Store as shown in FIG. 8.

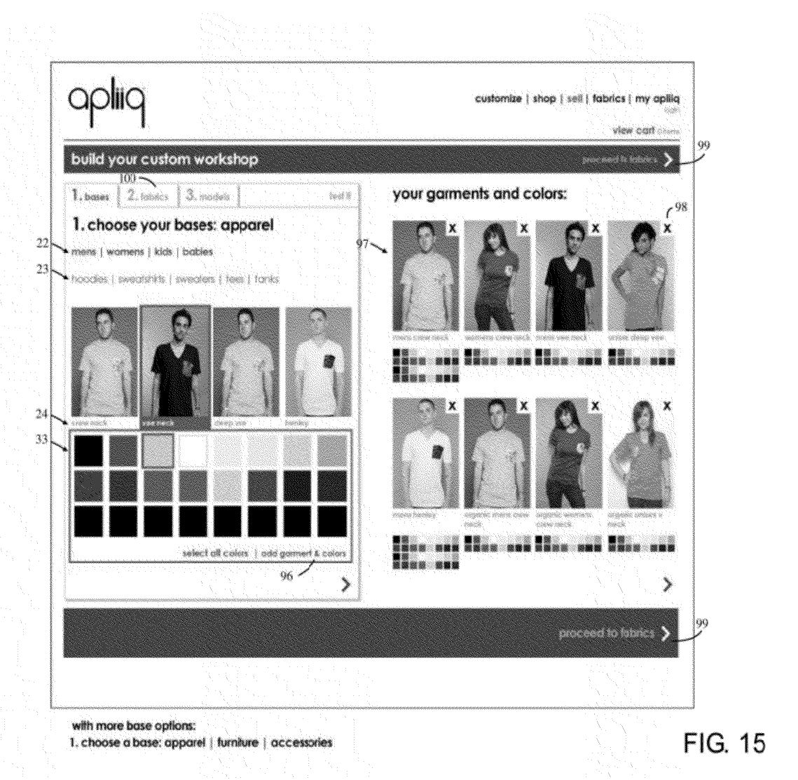

FIGS. 15-18 highlight an embodiment for a Store Owner to create a Sub-Customizer for his/her Customers to design their own Products. In the case of a custom Appliqué Store, graphic elements such as tabs, buttons, or other forms of division can be used to differentiate each step and direct Users through the different steps of the process of creating or updating their own Sub-Customizers, in a similar manner as directing a User through the process of creating a custom Product.

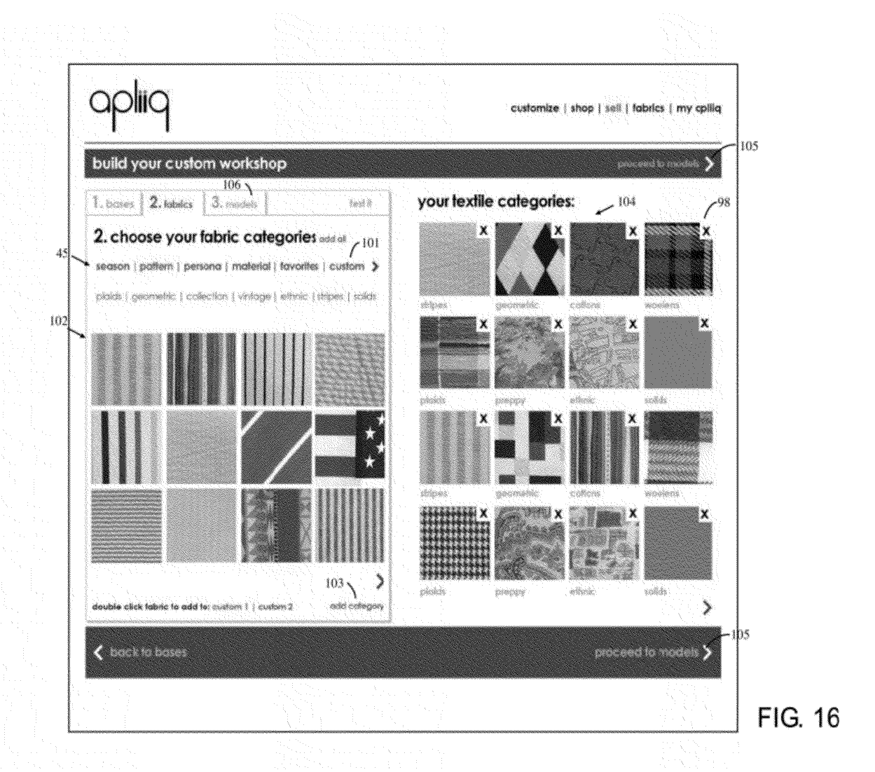

FIG. 15 shows the first step in the custom Sub-Customizer creation or updating process. A screen can be used to prompt the Store Owner to select his/her Base garments and available Color options for each garment. Base garments are first divided by Category (22) and further by Category type (23) (i.e. hoody, tee shirt, tank top, etc.). For example, when a User selects a Base garment type such as a tee, all the subcategories (24) of that section appear, such as crew neck, V-neck, deep vee, and Henley. Once a Base garment is clicked and highlighted, the Store Owner can view and select all available Colors or specific Colors (33) from which his/her customers can choose. For example, in the case of a school or team affiliation, a Store Owner may choose to offer Base garments in his/her team or school Colors for his/her Customers to purchase. After clicking “add garment & colors” (96) the Base garment and associated Color options appear on the right side of the screen (97). A Store Owner can delete each Base garment selection at any point by clicking “x” (98) on the image of the Base garment. As a Store Owner adds new garments, they populate the right hand side of the screen under “your garments and colors.” When the Store Owner is satisfied with his/her selections, he/she can select “proceed to fabrics” (99) or click the second tab—“fabrics” (100) to move to the next step (FIG. 16).

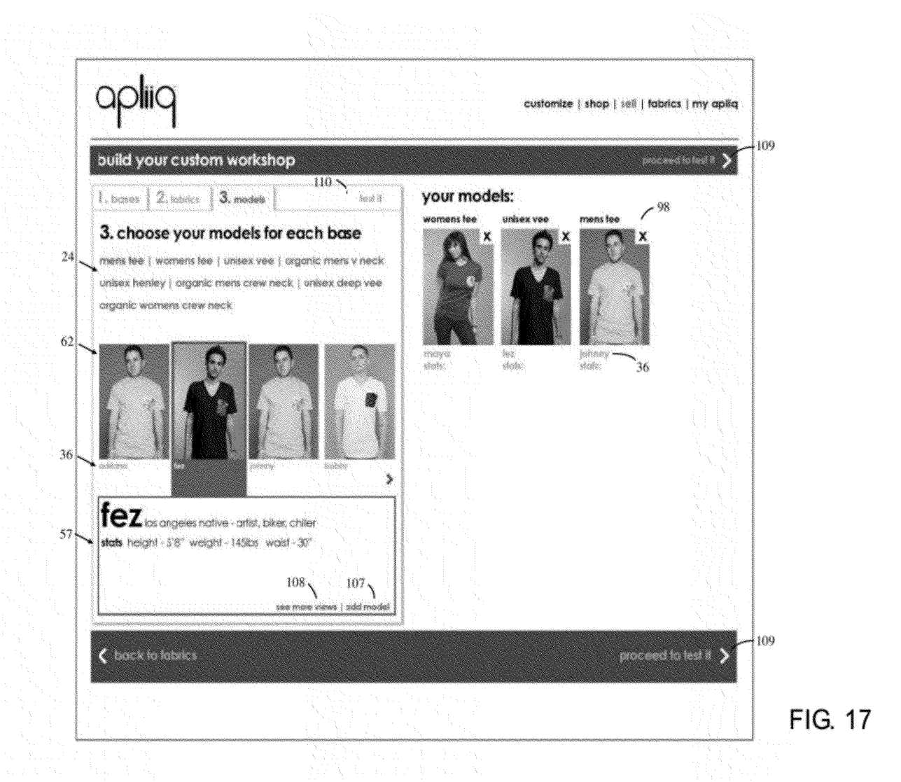

FIG. 16 displays the Fabric options that a Store Owner can select to offer his/her Customers when they design their custom Products. Fabric categories include Pattern type, Season, Persona, Material (45) or the Store Owner's custom (101) choices to make up his/her own category. When a Store Owner selects a Category, the subcategories appear as text, and when a Store Owner clicks a subcategory, images of Fabrics in that subcategory appear below in a grid (102). A Store Owner can pick the Fabric subcategories he/she would like to offer his/her Customers or he/she can select specific Fabrics to create his/her own custom category with a hand picked selection for his/her Customers. Once the Store Owner finishes defining the subcategory and clicks “add category” (103), the category appears on the right side of the screen with an image and defining text (104). The Store Owner may delete a category at any point by clicking “x” (98) on that particular Fabric Category image. When a Store Owner is satisfied with his/her Fabric offerings he/she can select “proceed to models” (105) or the third tab “models” (106) to continue the store creation process, as illustrated in FIG. 17.

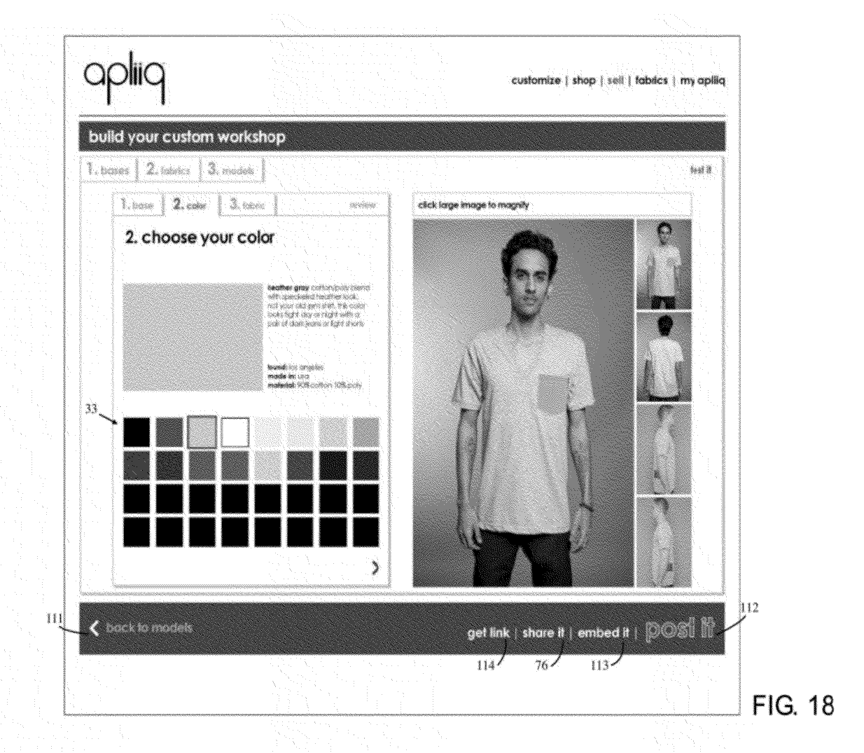

FIG. 17 displays how a Store Owner can choose the Models that will appear in his/her Sub-Store. These Models wear and display the Bases for Product customization and each Store Owner has the ability to choose which Models will be best for his/her audience and Customers. Each set of Models corresponds to the Base garment previously selected in the first step (FIG. 15). When the Store Owner selects the Base garment (24), the available Models' names (36) appear and the Store Owner can choose which Models he/she wants to use for that garment by clicking on the Model's image (62) and then selecting “add model” (107). When a Store Owner clicks on a Model image, several details about the Model can appear such as the name of the Model, a small biography and statistics about the Model such as height, weight, waist and size (57). The Store Owner can also view more images of the Model by clicking “see more views” (108). When the Store Owner selects a Model for a particular Base garment, the Model image (62) appears on the right side of the screen under the name of the Base garment (24) and the Store Owner can remove the Model at any point by clicking “x” (98) on the Model's image. When a Store Owner is satisfied with his/her chosen Models he/she can select “proceed to test it” (109) or the fourth tab “test it” (110) to move to the last step in the store creation process, as illustrated in FIG. 18.

FIG. 18 shows the “Test it” screen in which the Store Owner can run through the Product customization process to view how his/her Customers will design Products in his/her Sub-Customizer. This example screen shows step two of the customization process in which a Customer would choose the Base garment Color (33). However, all steps of the customization process can be tested on this screen when the computer system with associated software and database are running. If the Store Owner is not satisfied with his/her Sub-Customizer he/she may click “back to models” (111) or select any tab to make changes to his/her selections. If the Store Owner is satisfied and ready to activate his/her Sub-Customizer for other Users to see, he/she can click “post it” (112). The Store Owner can also click “embed it” (113) to copy the necessary code to embed his/her Sub-Customizer on an external or different website. The Store Owner can click “get link” (114) to view and copy his/her unique system-generated Sub-Store URL to send to others who wish to view the custom Sub-Store. Finally, Store Owners can click “share it” (76) to connect directly to social media websites and post a link to the new or updated custom Sub-Store and Sub-Customize on their profile pages. If any of these four options (“post it”, “embed it”, “get link”, “share it”) are selected, the Sub-Customizer is saved in the database which then activates the Sub-Customizer on the host site.

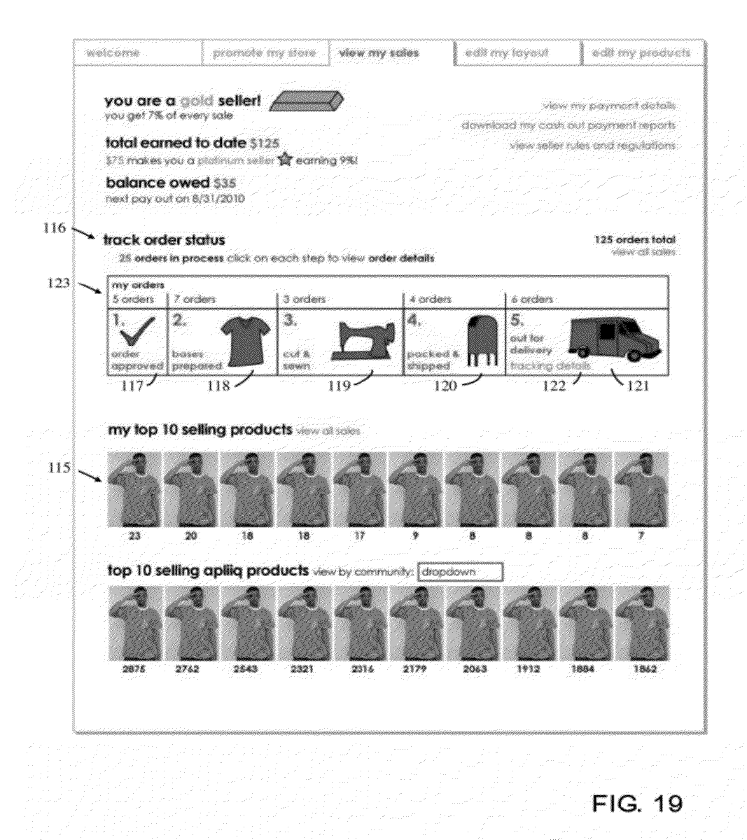

This simple four step process allows a Store Owner to specify which options (database filters) he/she would like to have appear in his/her Sub-Customizer. Once a Store Owner has created his/her Sub-Customizer, other Users may browse the Sub-Customizer and the Components that the Store Owner selected. A Customer interacts with a Sub-Customizer in the same manner as the Customizer and may customize Products and purchase them. A Store Owner can view his/her sales and get paid—in this case based on a “Commission”, (amount of money owed to the Store Owner based on a variable percentage of the total Order value) structure- and earn a “Selling Status” which is defined as a tiered award and recognition platform. In a preferred embodiment, Store Owners earn a higher Commission rate as their sales and Selling Status increase. Additionally, Store Owners can see their top selling Products (115) as shown in FIG. 19, via a link from their central Store Owner Controls (91) illustrated in FIG. 14. Store Owners can also track current Orders through the Just-in-Time Production process in the “Order Tracker” (116) shown in FIG. 19.

The Order (116) is a visual way to see the progression of a Customer's purchase of Products (Order) from the time an Order is placed on the website to the time the Order is delivered to the Customer. In the illustrated embodiment, there are five points where the Order Tracker displays the status of an Order. The first is “Order Approval,” (117) when a Customer's Order transaction has been received and successfully approved by the computer system and associated software and database. When the Base garments have been Ordered and received from a Supplier, the status of the Order changes to “Bases Prepared” (118). When the Fabric Patches have been cut and sewn onto the Bases, and the Product(s) meet(s) quality assurance procedures, the status of the Order becomes “Cut & Sewn” (119).

The next status is “Packed & Shipped” (120) when the Order has been packaged, shipping labels have been printed, and the Order has been shipped. The fifth and final status is “Out for Delivery” (121) where the time a Customer can expect a shipping carrier to deliver a package containing the Order can be displayed. During the Out for Delivery phase, the Customer can see the tracking information (122) from the shipping carrier and more information about the exact location of the package.

The software and database system (including the Order Management system) takes into account several aspects to calculate the estimated delivery date of an Order. The system calculates the expected time needed to complete each phase in the Order Management process and it estimates a final expected delivery date for when the Customer should receive the ordered Product(s). If there is a delay with the preparation of a Base (e.g., a Base is out of stock from a Supplier and “Backordered”), the Operator can enter an expected arrival date of the Base and the software and database system accommodates for the delay by adding the additional time specified by the Operator to the expected delivery date. Similarly, if there was a mistake during manufacturing and a Base needs to be reordered, the Operator can note the mistake in Order Management and the Order Tracker's expected dates will be revised accordingly.

There are small variations with the display of the Order Tracker depending on who sees it. For a Store Owner, the Order Tracker displays how many Orders are in each phase of the process (123) for each Product that was purchased from his/her Store. A Customer, however, can see the Order Tracker on an email Invoice and instead of displaying how many Orders are in each phase, the Order Tracker displays an expected completion date for each phase. Lastly, the Operators can use the entire Order Management system (a glorified Order Tracker, unfiltered for a specific Customer or a specific Store Owner) to track every Order from every Customer from every Store throughout the entire process of manufacturing, preparing, and shipping the Orders.

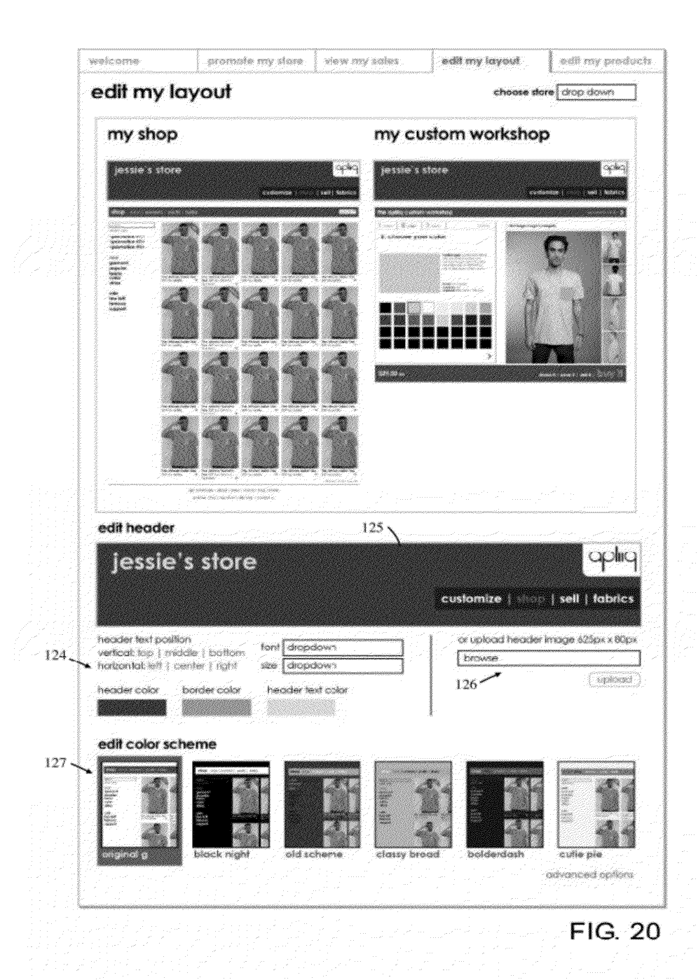

As shown in FIG. 20, Store Owners can also alter the appearance of their Sub-Stores and Sub-Customizers by clicking the “edit my layout” button on their central Store Owner Controls (94) shown in FIG. 14. In FIG. 20, a series of color and text options (124) are offered for the Store Owners to edit the headers (125) for their Sub-Stores and Sub-Customizers. Also, Store Owners can upload an image (126) to customize the header space for their Sub-Stores and Sub-Customizers. For example, the Store Owner can choose colors for their overall Sub-Stores and Sub-Customizers by selecting from the pre-designed color schemes (127) on the bottom of the page.

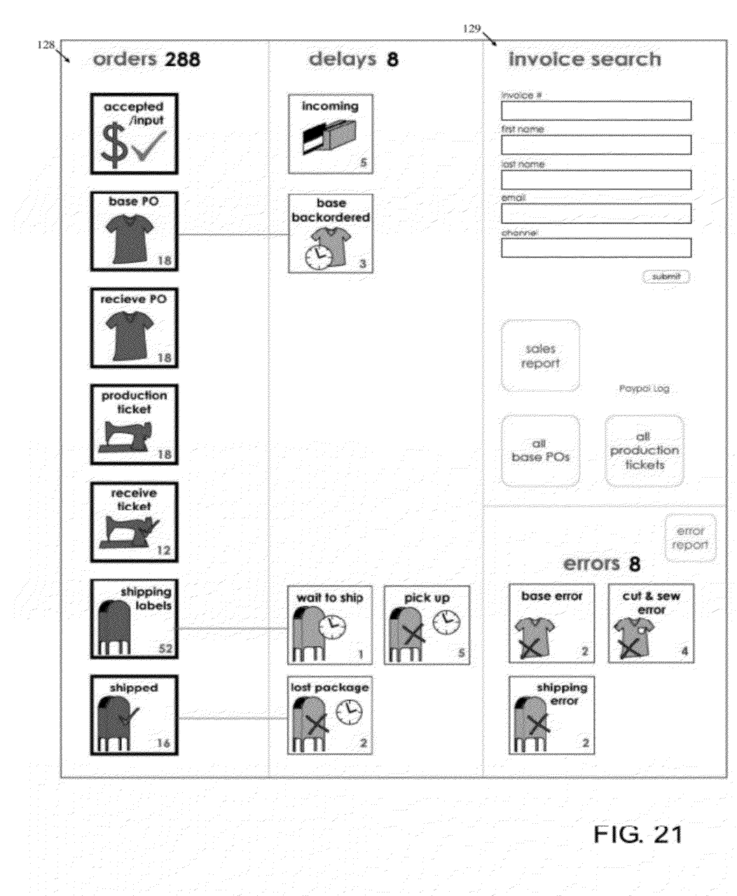

FIG. 21 shows a central dashboard that controls the Order Management process and makes it easy for the Company to view all Orders (128) throughout the Production process. There are a series of well-defined links that allow the Operator to see how many Orders are in each phase of Production. There is also a place to look up Orders by invoice number, Customer name, Channel and/or Customer email. Operators can also use links to view sales reports for all Channels, view all base POs, view all Production Tickets and see an error log for any payment processing errors. (129).

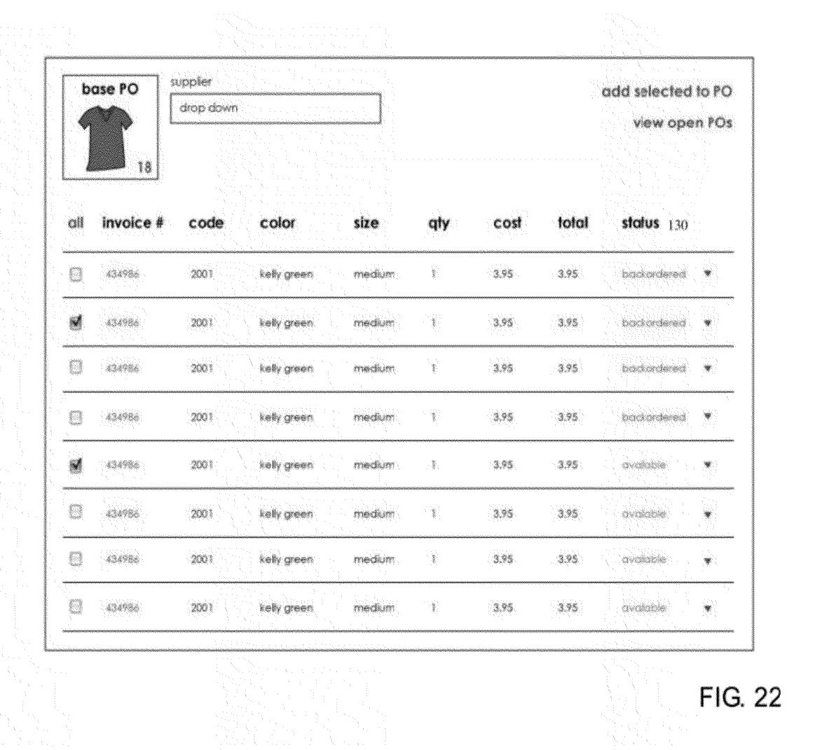

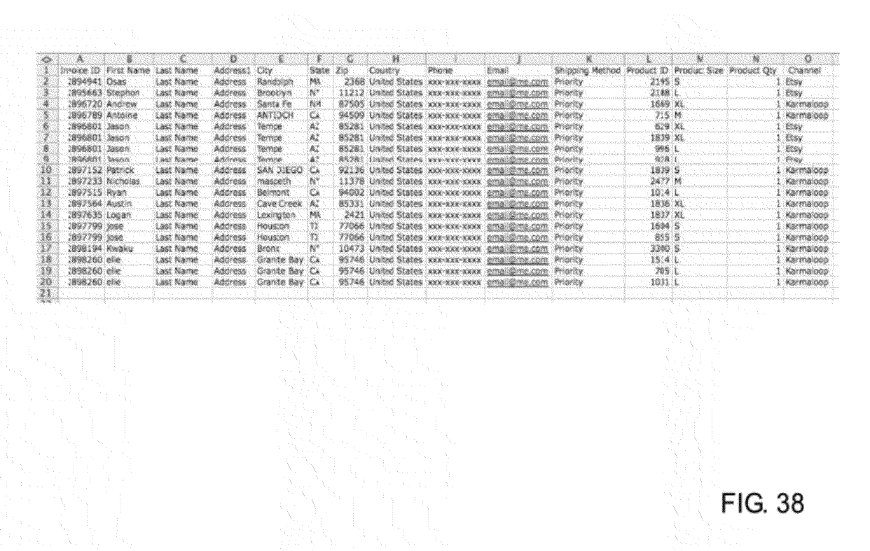

Orders automatically flow into the Order Management system from the database when Customers purchase Products. Customers are then automatically sent an email with confirmation of a successful transaction and the expected date of arrival for their Orders. This information is provided on an Order Tracker that is part of the email. The Operator may also manually input Orders from external points of sale (see FIG. 38). All approved Orders start in a Base PO list as shown in FIG. 22, where the Operator can add items individually (or all at once) to a Purchase Order for a selected Supplier. If items are Backordered from a Supplier, the Operator can edit the status of a Base (130) and the change will reflect in the front end Store and Sub-Store web pages so Customers know to expect delays for any Products with that Base.

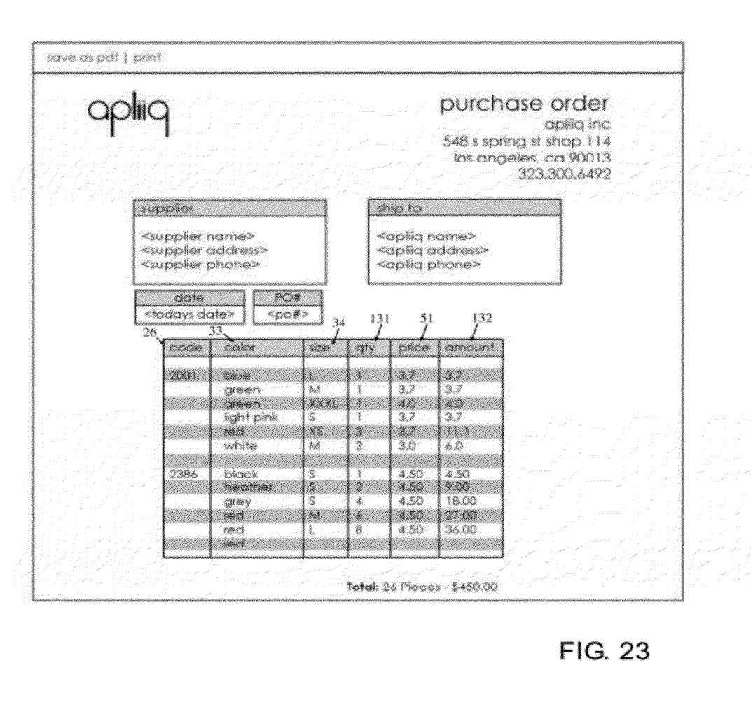

FIG. 23 shows an example of a Purchase Order that the Operator generated from Orders on the Base PO list. The Purchase Order lists pertinent information of each item for the Supplier, such as the Supplier Code (26), Color (33), Size (34), Quantity (131), Price (51) and Amount (132). The Operator can then receive a Purchase Order and denote if any of the items were damaged and flag the item as a Base error and automatically move the item back to the Base PO list to be reordered from the Supplier. This allows the Company to keep track of mistakes and minimize delays in Production. Moreover, these delays can be automatically relayed to the Customers in their login-protected account areas.

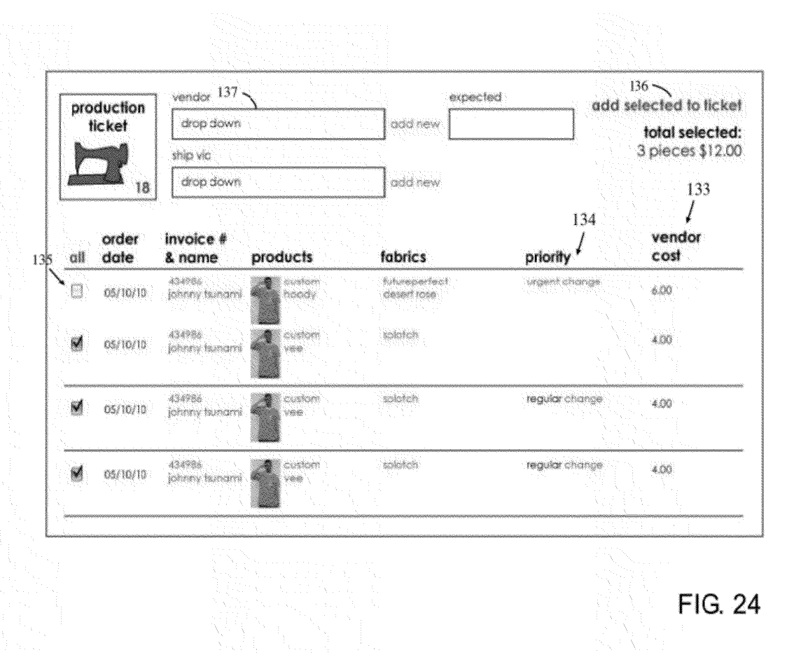

The items that the Operator accepts and receives move to a Production Ticket list, which displays details of each item in an Order and the Cost to manufacture (133) (add patches and accents) for the items, as illustrated in FIG. 24. Each item listed has a Priority status (134). If there are any delays in the Order Management process, an Operator can change the Priority of an item from “regular” to “urgent” and those Orders are produced first. On the Production Ticket list, the Operator can select items (135) to add (136) to a selected Vendor's (137) Production Ticket.

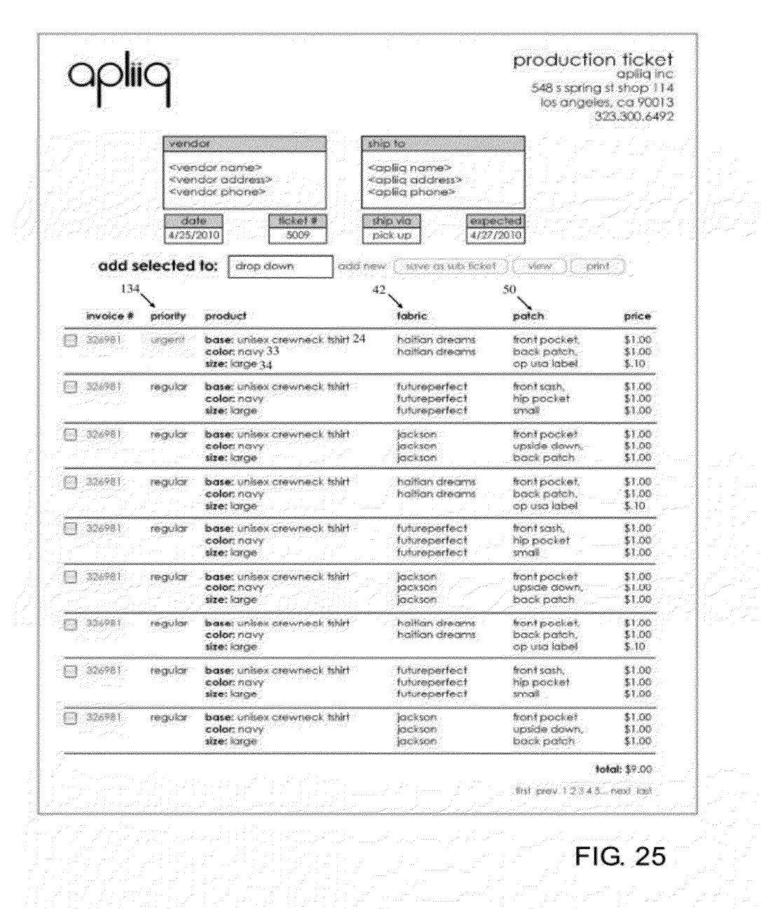

As shown in FIG. 25, the Manufacturer can refer to the Production Ticket for details about each item such as Priority (134), Base (Type (24), Color (33) and Size (34)), Fabrics (42) and Patches (50).

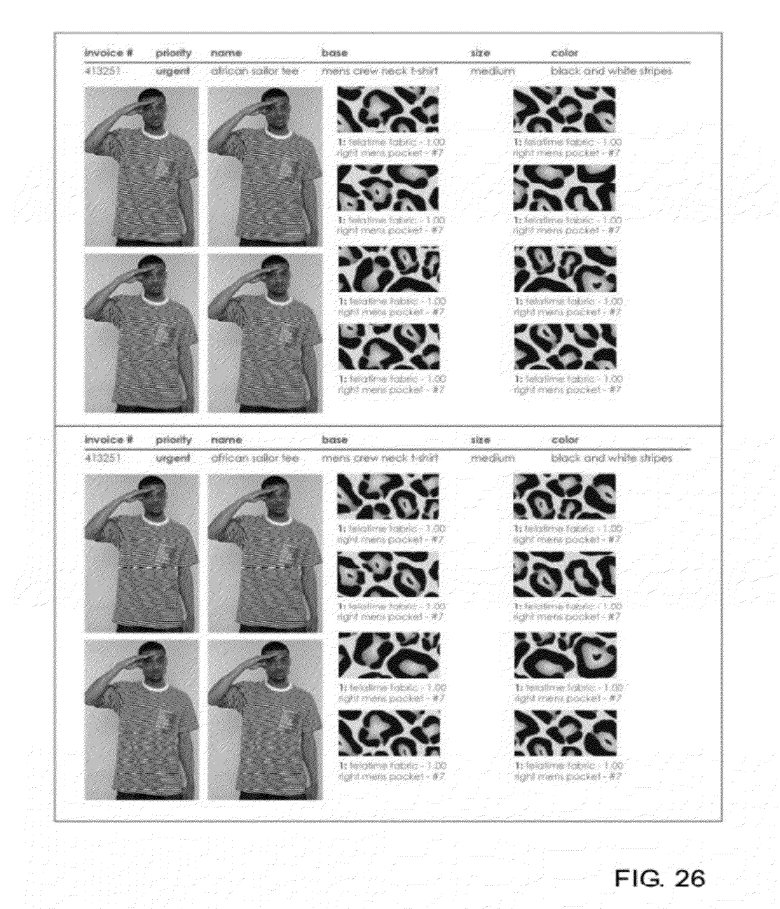

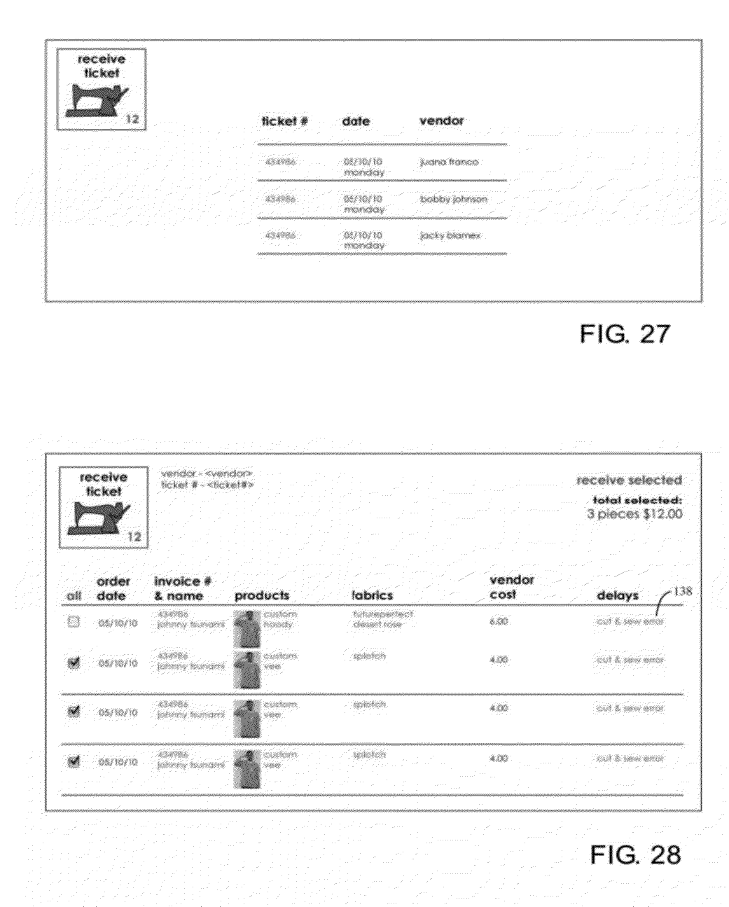

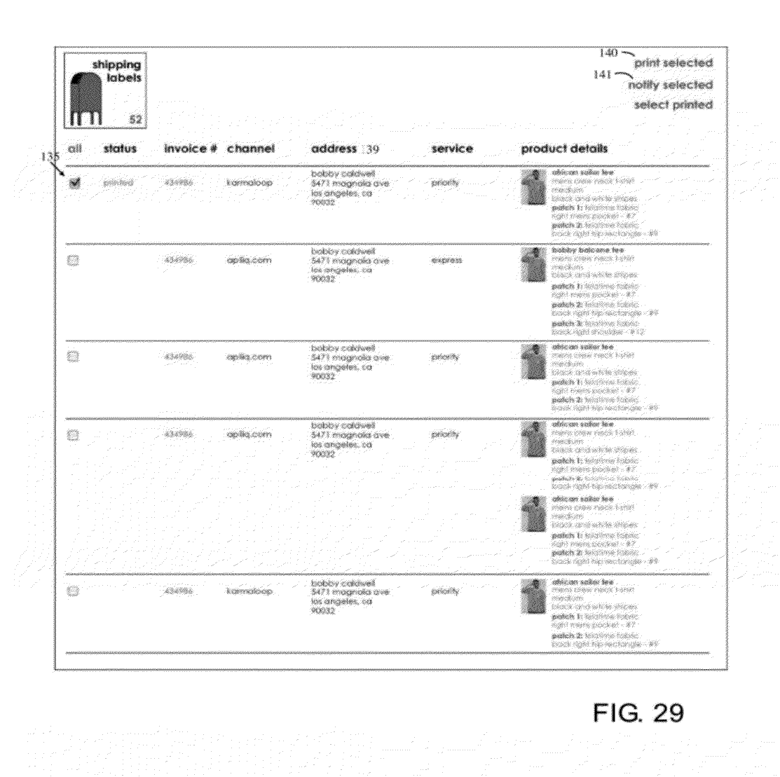

FIG. 26, demonstrates in more detail the information of each item needed for the Manufacturer. The Operator can select from a list of open Production Tickets, an example of which is shown in FIG. 27, and receive specific items or all items from that Production Ticket, as illustrated in FIG. 28. If there was an error during manufacturing, the Operator can note that by clicking “Cut & Sew Error” (138) and the item will be flagged in a report, removed from the Production Ticket, placed back in the Base PO list to be reordered, flagged with a “Urgent” Priority status, and a notification of delay may appear for a Customer to see in his/her login-protected account area and/or be emailed directly to the Customer.

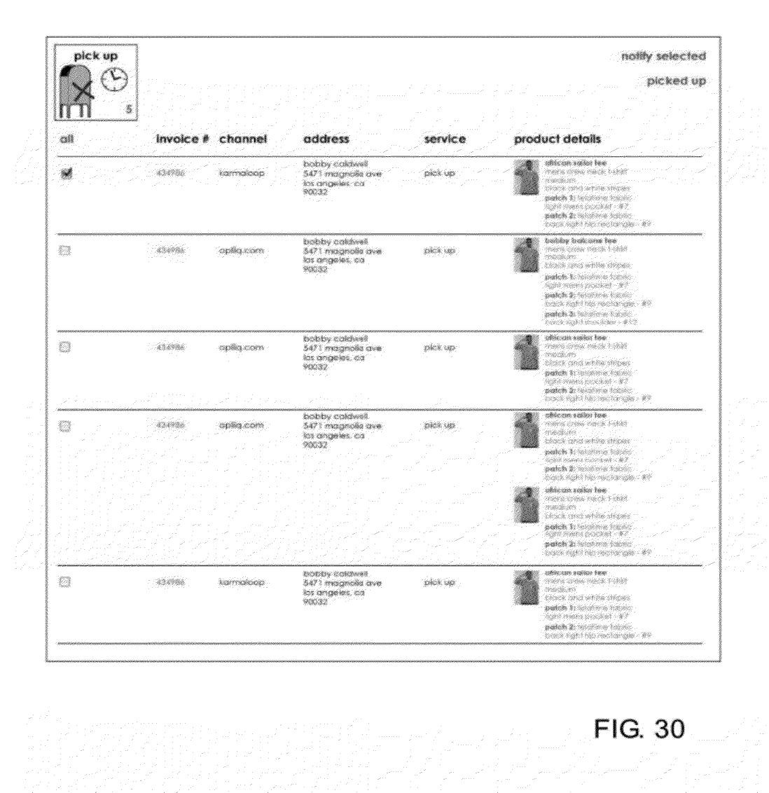

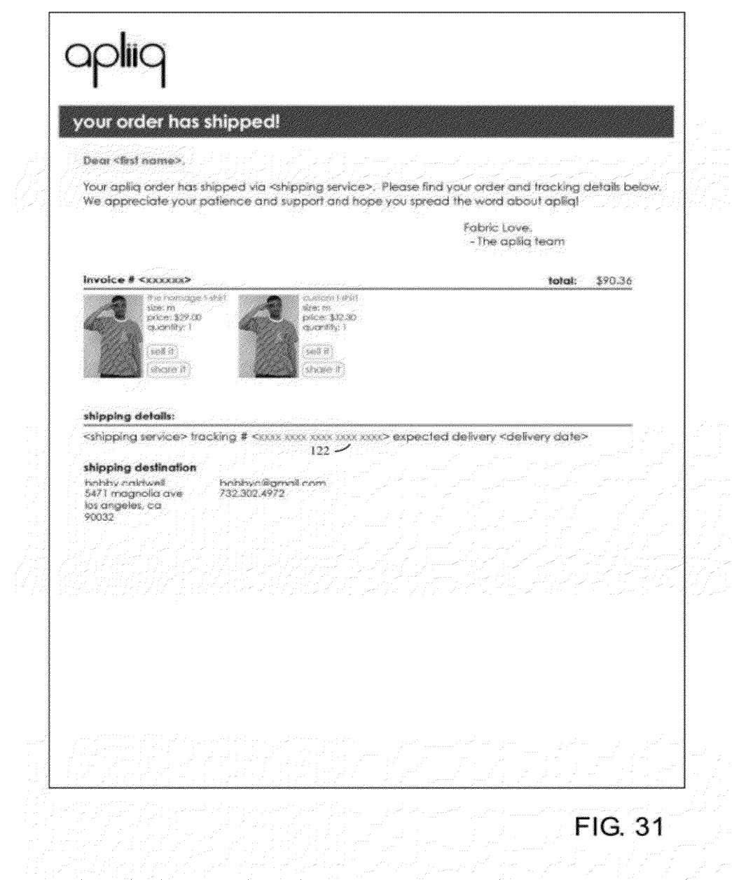

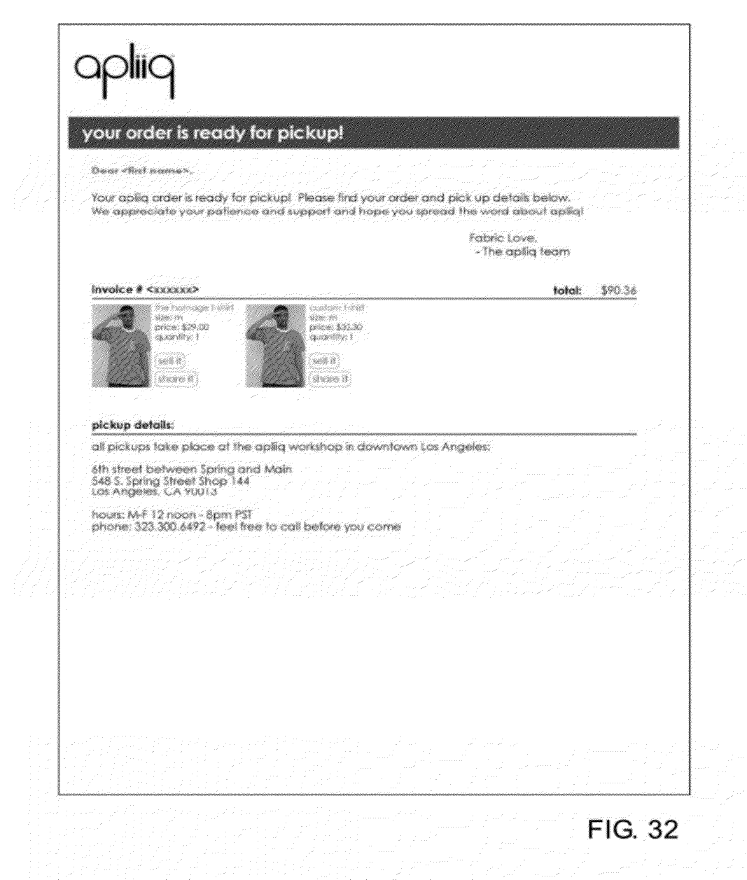

When an entire Order has been manufactured successfully, the Order moves to a list for Shipping Labels as shown in FIG. 29 or a list for Pick Up as shown in FIG. 30, depending on the shipping method the Customer selected during Checkout. For Orders that are shipping, the Operator can select Orders (135), automatically generate shipping labels based on the total Weight of the Order, the shipping address (139) and the capacity of packing materials from a shipping carrier, and then print the selected labels (140) and notify the Customers (141) directly with a standardized email as illustrated in FIG. 31. The email includes tracking information (122) for the package. For Pick Up Orders, the Operator can notify the Customer directly with a standardized email that the Order is ready for pick up, as shown in FIG. 32.

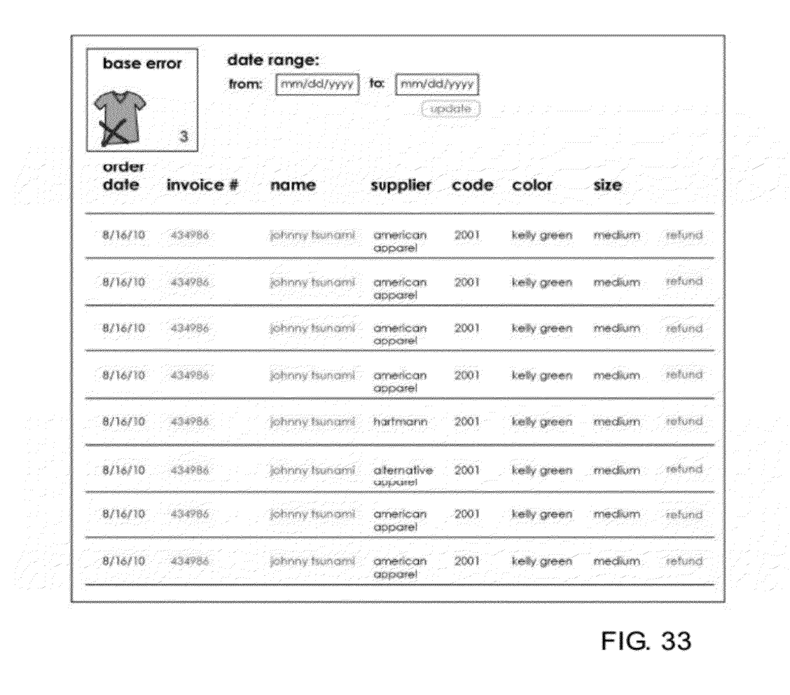

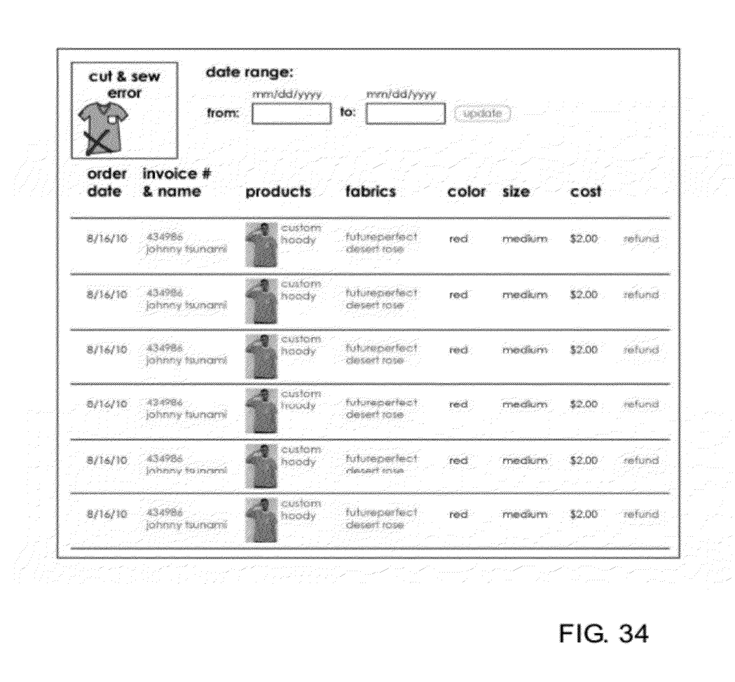

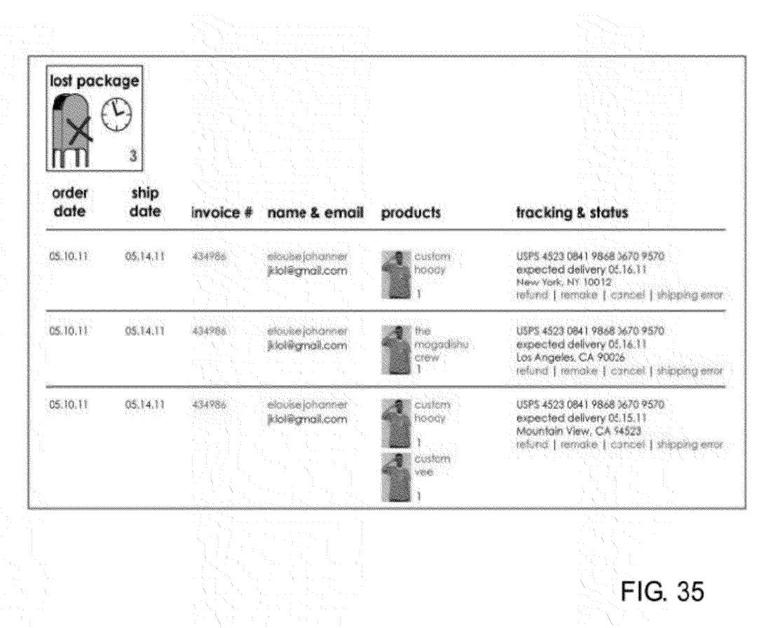

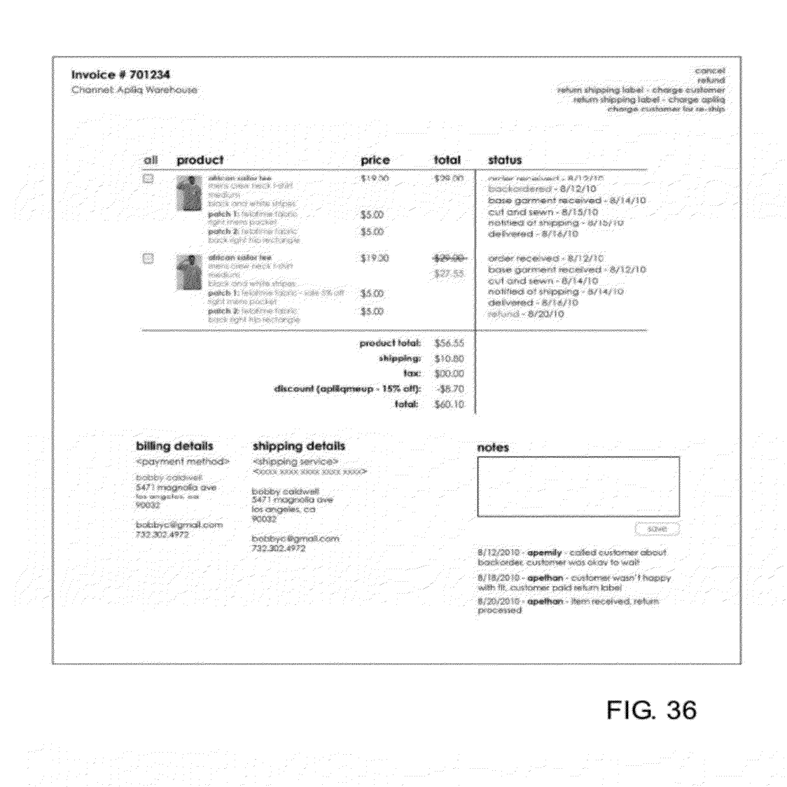

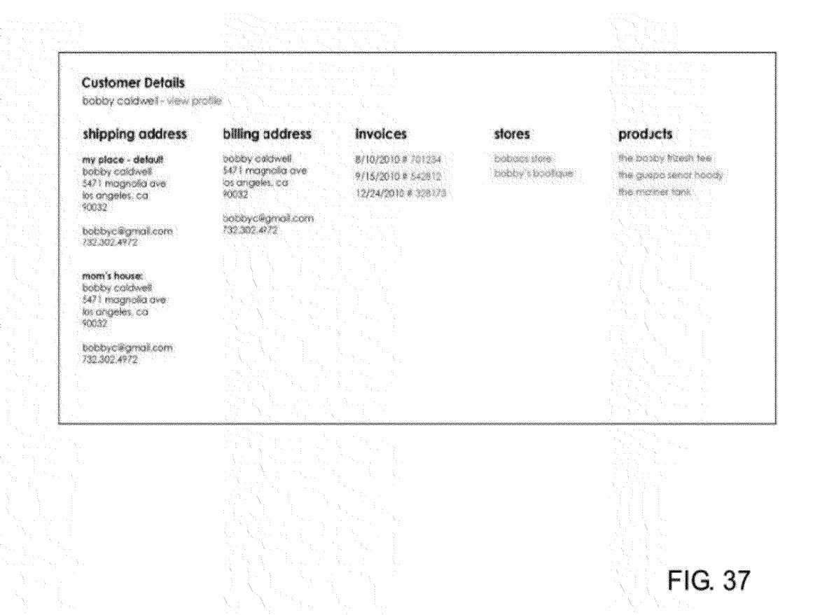

The Order Management Component also functions as a Customer Service database by tracking delays as shown in FIG. 33, Production errors as shown in FIG. 34, lost packages as shown in FIG. 35, invoice details as shown in FIG. 36, and customer details as shown in FIG. 37.

In a preferred embodiment of the invention, FIG. 38 illustrates the format of a CSV file used for inputting Customer and Order data to the Order Management system. Such data includes customer name, shipping address, phone number, email, invoice number, shipping method, Product ID number, size, quantity and Channel. Once uploaded to the Order Management system, the data on this CSV file is entered into the system which enables multiple Orders from various external Channels to be processed alongside Orders from the internal system.

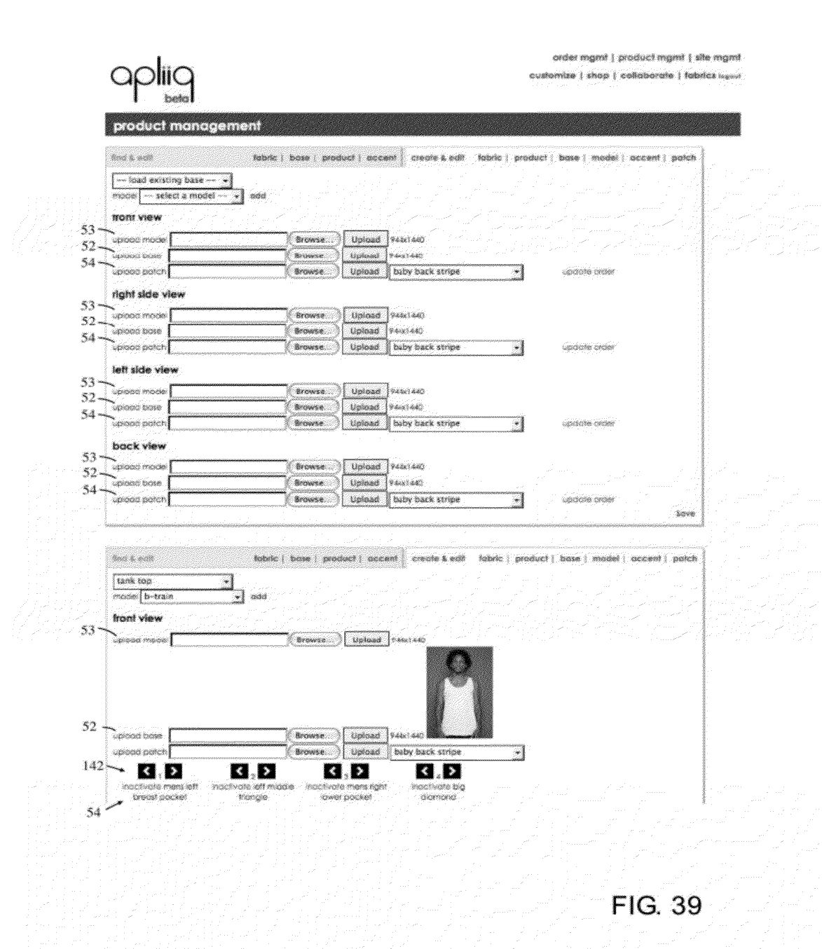

FIG. 39 illustrates a preferred embodiment for the method used to upload Patch and Model layer images to the database. All four views for each Model on each Base garment include Base (52), Model and background (53) and Patch images (54) that are all uploaded on this screen. The lower portion of FIG. 39 shows how the screen looks when one of the views has been populated with images. See FIG. 6 for an alternate embodiment in which all Model data and images are uploaded and referenced through a CSV file. Operators can manipulate the order of the Patches on the front-end Customizer so that smaller Patches appear on top of larger Patches and are easily clickable by Users. The Patch layers can be rearranged here by clicking the black arrows (142) to control which Patch layer is on top of another in the Customizer.

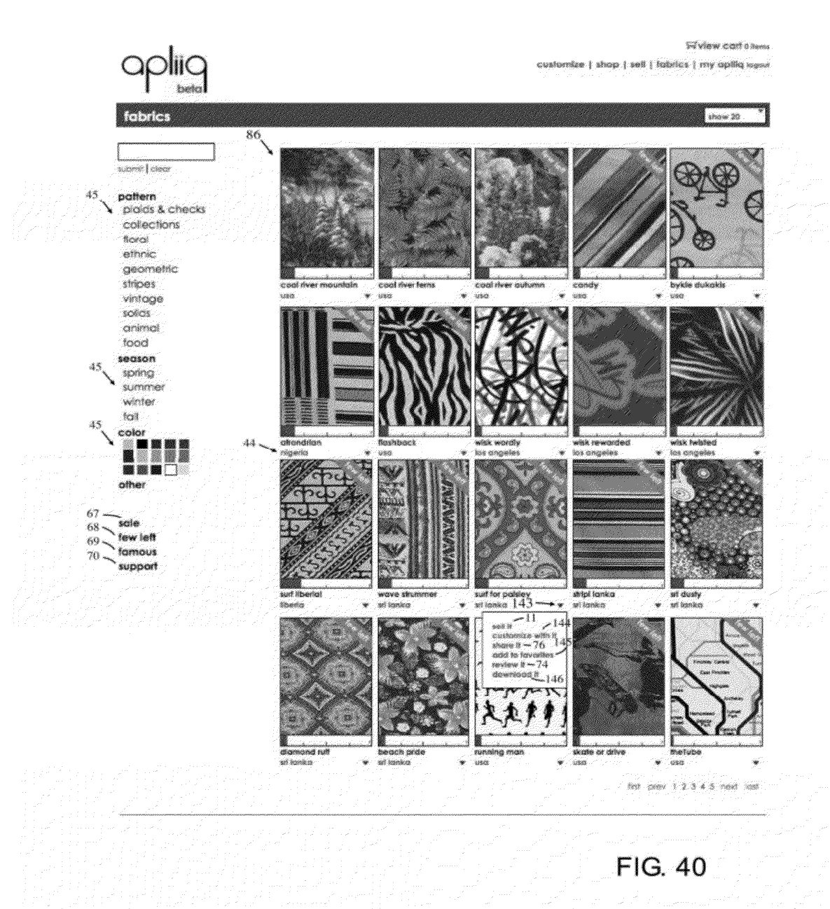

FIG. 40 shows a preferred embodiment for displaying Components used for customization in which Fabric images (86) are displayed in a grid much like the Product images are displayed in FIG. 8 (“Fabric Page”). A User can navigate to see specific Fabrics by selecting from the Categories in the navigation on the left (Pattern, Season (45), Color (45), Sale (67), Few Left (68), Famous (69), Support (70) . . . ). Under each Fabric image is the Fabric name and Origin (44). There is also a arrow (143) that becomes a dropdown menu when clicked with the options to: Sell It (which adds the Fabric to a User's Sub-Customizer) (11), “Customize With It” (which loads the Fabric in the Customizer, along with a Base that accepts the Fabric) (144), Share It (through integrated links to other websites such as Twitter or Facebook) (76), “Add to Favorites” (which saves and displays the Fabric in a specific section within the Store Owner Controls) (145), “Review It” (which allows the User to rate, comment, and/or upload photos or videos about the Component and the information is automatically saved and displayed publically for other Users to see) (74) and “Download It” (which allows Users to save an image of the Component to the User's computer, phone and/or other device that can use the invention through an Internet connection) (146).

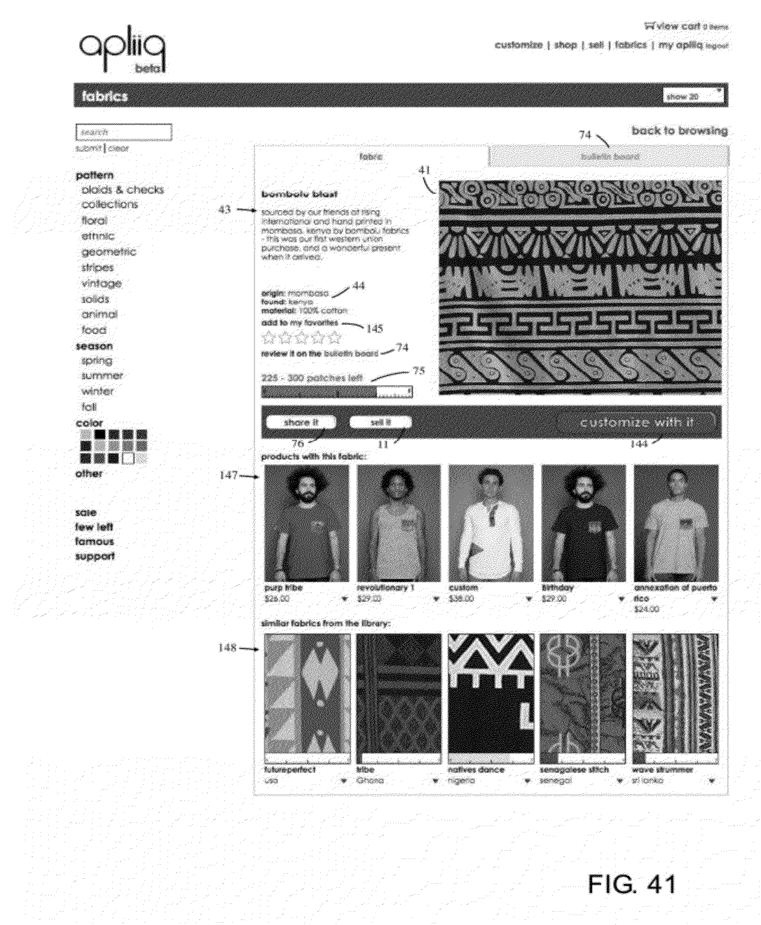

In the preferred embodiment, when Users click on a specific Fabric image (86) they are directed to the Fabric Detail Page (FIG. 41) that displays buttons enabling the same functionality as the links in the dropdown arrows on the Fabric Page. The Fabric Detail Page also has a description about the Fabric (43), it's Origin (44), where it was Found (44) and how much is left on the Fabric Meter (75). There are also images that show and link to Products with that specific Fabric (147) and images that show and link to other similar Fabrics that Operators have uploaded in Product Management and have made available in the Fabric Page (148). Finally, in this preferred embodiment, there is a secondary tab which leads to the “Bulletin Board” where a User can add comments, ratings, videos and photos about the particular Fabric and the information is automatically saved and displayed for other Users to access (74).

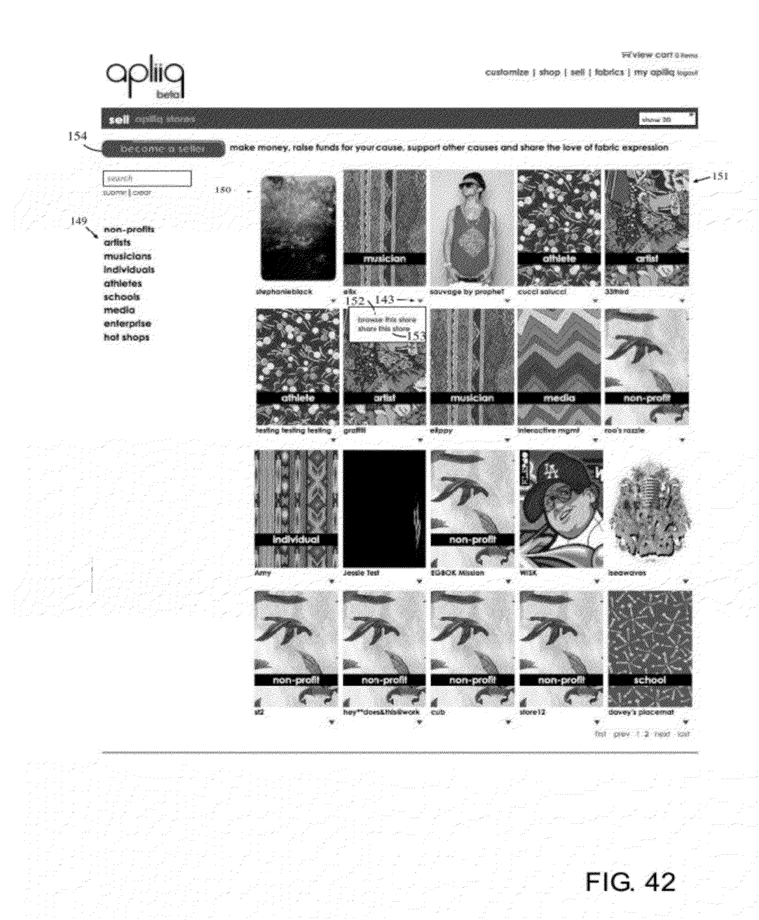

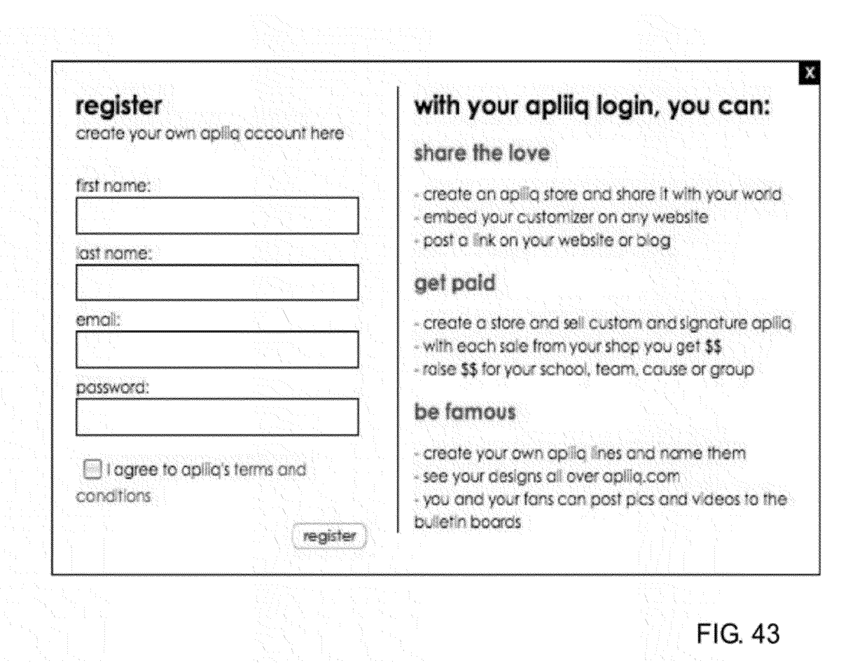

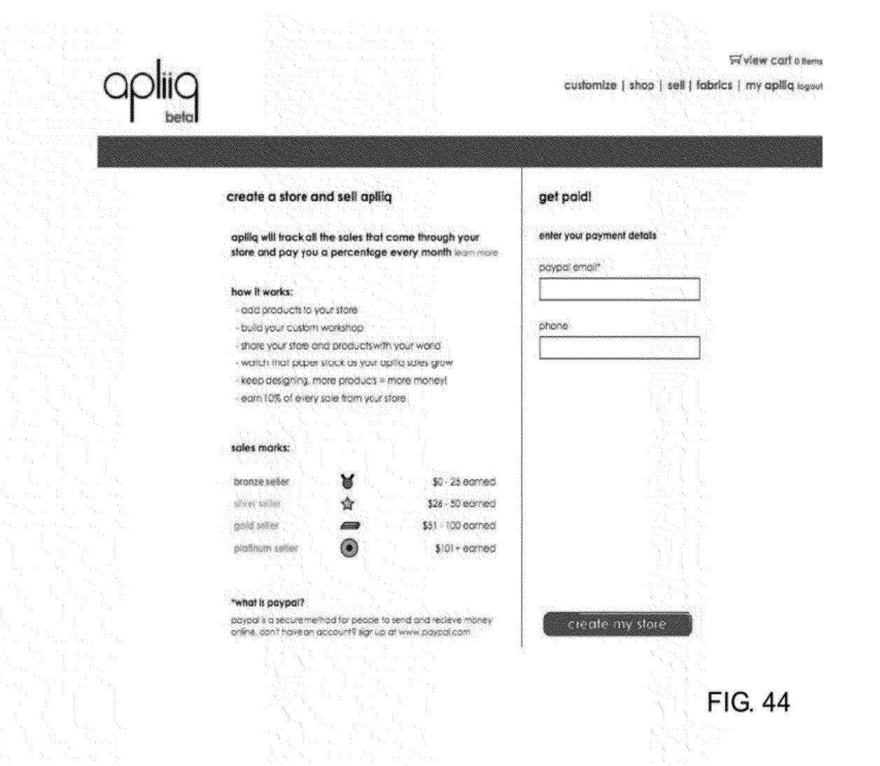

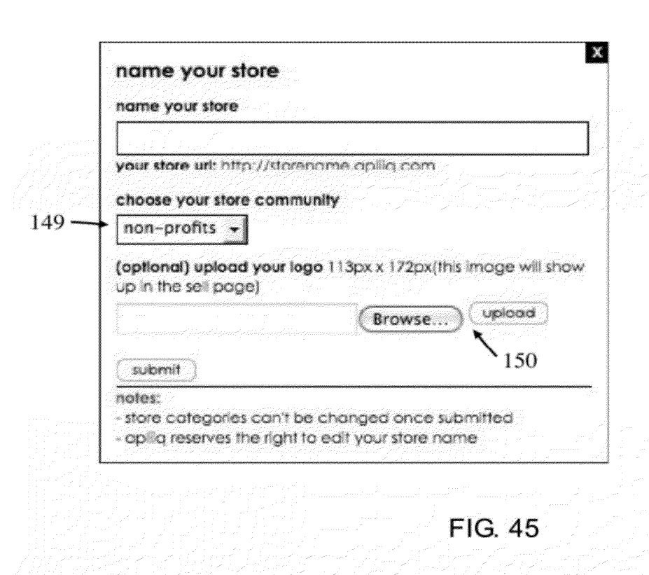

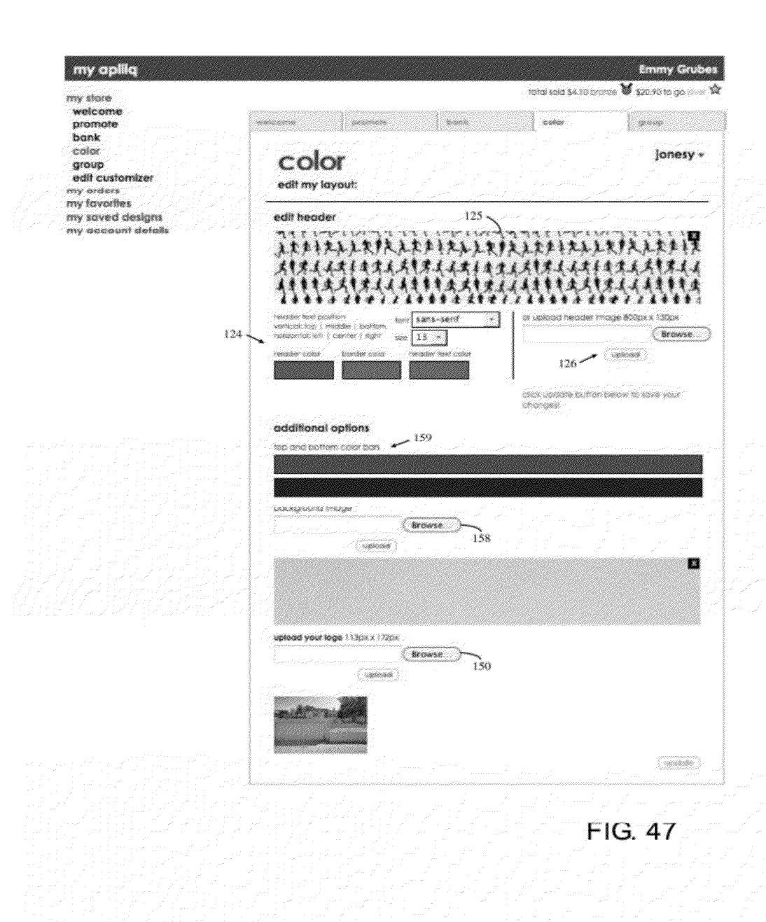

FIG. 42 illustrates the preferred embodiment of a “Sell Page” (which displays an image and name for each User's Sub-Store that each link to a User's Sub-Store). This page contains a side navigation that enables Users to view Stores by “Community” (a tag that Store Owners pick to represent themselves which is used for segmentation) (149). For example, Store Owners could choose to categorize themselves in the following Communities: artist, musician, non-profit, individual, enterprise, media, schools, athletes, etc. Users can filter through Stores by selecting a Community in the left navigation and they will see Stores that are categorized accordingly. Each Store “Logo” (image that represents the User's Sub-Store in the Sell Page) (150), which can be uploaded in the Store Owner Control's color tab (FIG. 47) and appears on this page as a link to the Store Owner's Sub-Store. If the Store Owner has not uploaded a Logo, a default image (151) for each Community type is displayed automatically. Arrows (143) beneath each Sub-Store's name and Logo indicate dropdown menus with the option for Users to “Browse this Store” (152) or “Share this Store” (153) through direct integration to Facebook and Twitter or through a unique hyperlink. There is also a “Become a Seller” button (154) that links Users to the registration process to begin building a Sub-Store to sell Products. When Users click Become a Seller, they see a series of screens where they must register for an account and agree to all Terms and Conditions (FIG. 43), input the payment information to receive their Commissions and other contact information (FIG. 44) and finally, choose a Sub-Store name and Community type (FIG. 45).

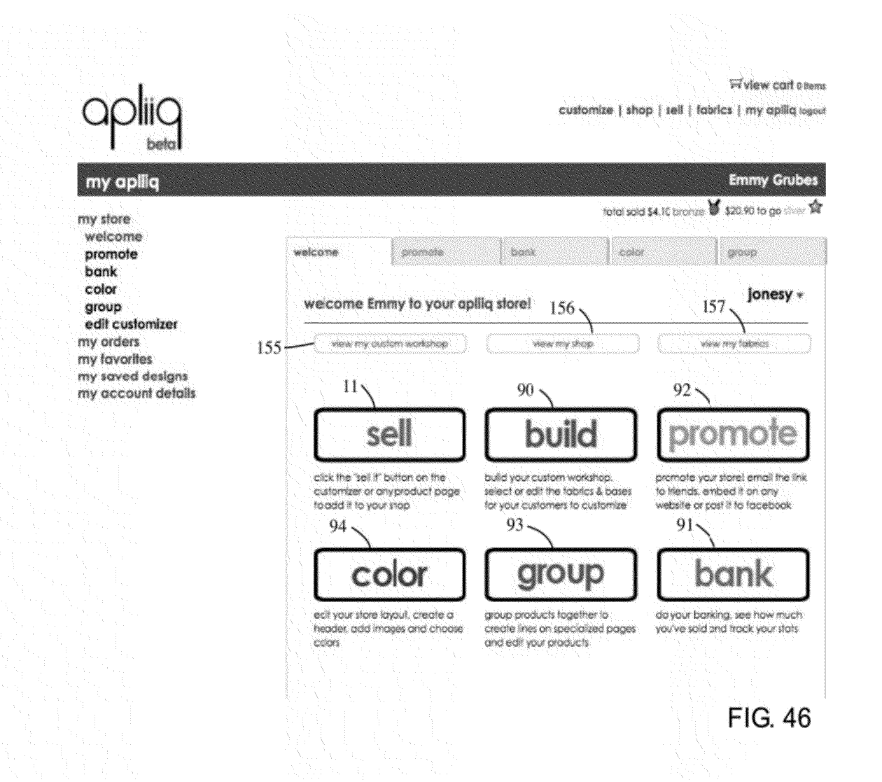

FIG. 46 is a screen shot of the preferred embodiment of the Store Owner Controls and shares the functionality of FIG. 14 with the Sell button (11), Build (90), Promote (92), Color (94), Group (93) and Bank (91) as well as additional buttons that enable a Store Owner to click to view their customized Sub-Customizer (155), Sub-Store, (156) and “Sub-Fabric Page” (a Store Owner's Fabric Page which displays only Fabrics that the Store Owner has selected to show as options in his/her Sub-Customizer) (157).

FIG. 47 is a screen shot of the preferred embodiment showing one aspect of the

Store Owner Controls. It shows where Store Owners can choose colors and images to customize the look and feel of their Sub-Stores and Sub-Customizers, as illustrated in FIG. 20. In addition to the header functionality shown in FIG. 20 (124, 125, 126), in this embodiment the Store Owners can upload background images (158) that appear in their Sub-Stores as well as a Logo (150) that appears in the Sell Page (see FIG. 42). In the preferred embodiment, Store Owners have the ability to customize the color of the bars that appear at the top and bottom of their Sub-Stores, Sub-Customizers and Sub-Fabric Pages (159).

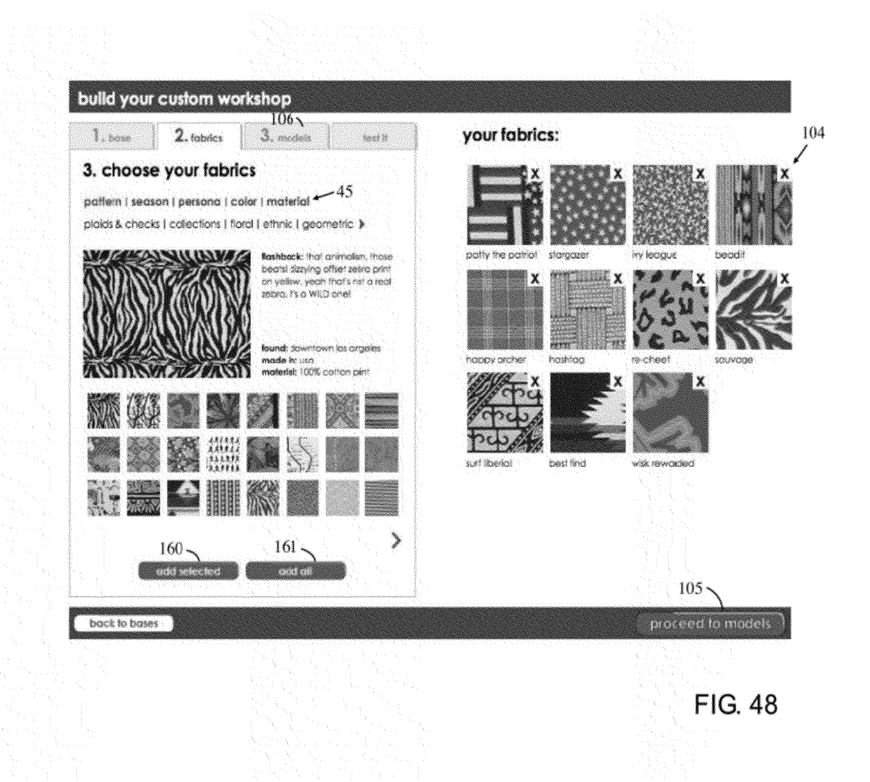

FIG. 48 illustrates a screen shot of the preferred embodiment of how the Store Owner selects Fabrics to add to their Sub-Customizer and Sub-Fabric Page. This figure is similar to FIG. 16 in which a Store Owner can select from Fabric Categories (45) to add to their Sub-Customizer, however in this case, the Store Owner navigates and selects individual Fabrics and clicks the “Add Selected” button (160) to save his/her choices to their Sub-Customizer and Sub-Fabric Page. There is also an “Add All” button (161) that enables Users to add all available Fabrics to their Sub-Customizer and Sub-Fabric Page.

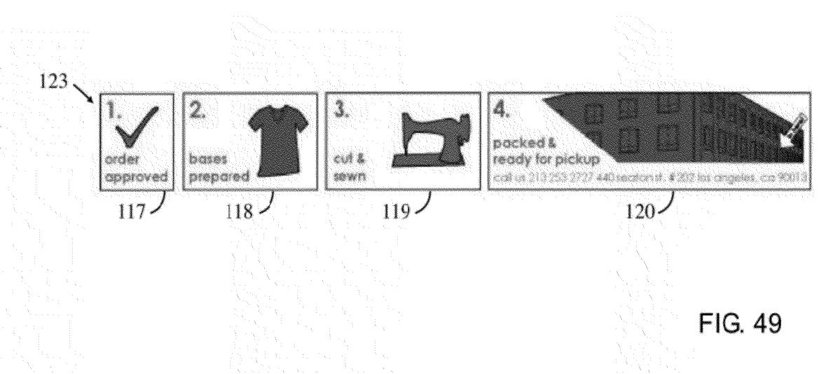

FIG. 49 illustrates a secondary view of the Order Tracker referenced in FIG. 19 (123). This view would appear if a Customer selects to pick up their Order from the production facility. In this case, the first three steps (117-119) are all the same as the Order Tracker for Orders that are shipping, however the fourth step (120) has an additional note that shows the Order is ready to be picked up and includes pickup location details.

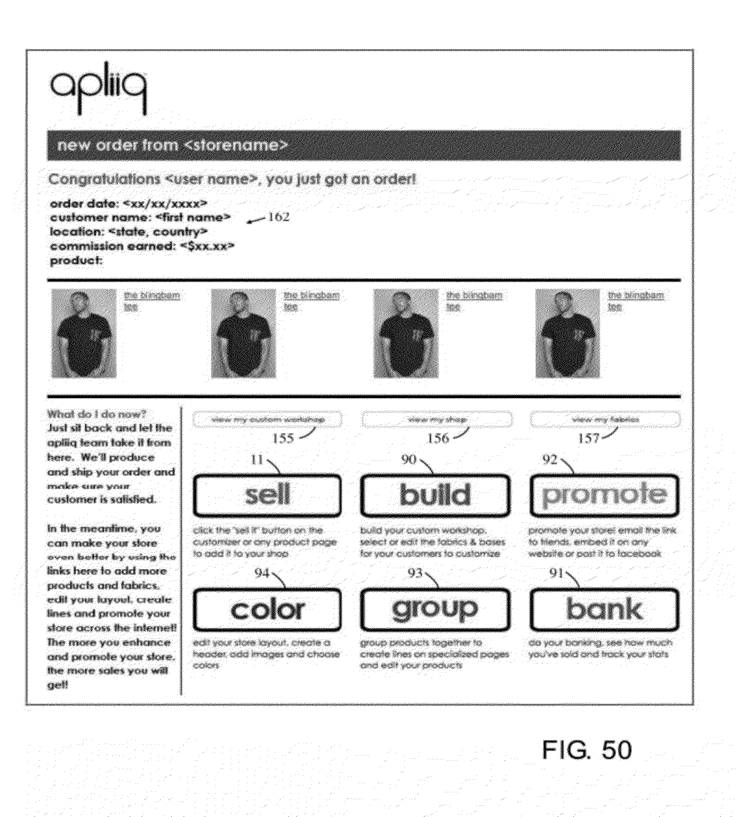

FIG. 50 is a screen shot of a preferred embodiment of a notification email sent to a Store Owner when they receive an Order from their Sub-Store. The email includes the links from the Store Owner Controls (FIG. 46) as well as information about the Product ordered, the Customer name and location and the Commission owed to the Store (162).

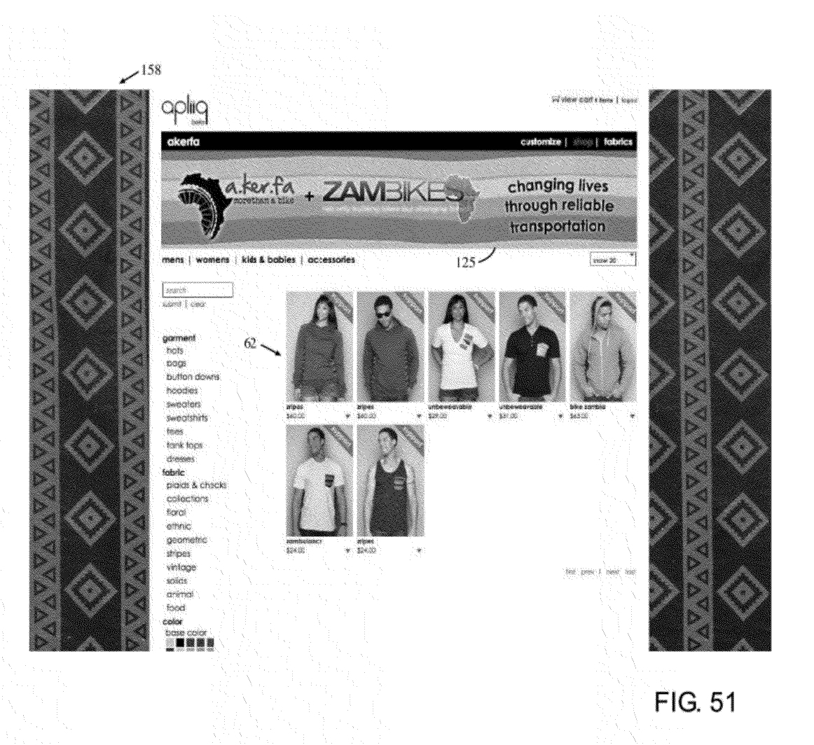

FIG. 51 illustrates a preferred embodiment of a User's Sub-Store as customized by the Store Owner. Here the Store Owner has added a custom background (158) and header (125) using the tools in the color tab of the Store Owner Controls (FIG. 47). This page displays and links to all the Products (62) that have been saved to the Sub-Store with the same functionality as the Company's primary Store (FIG. 8).

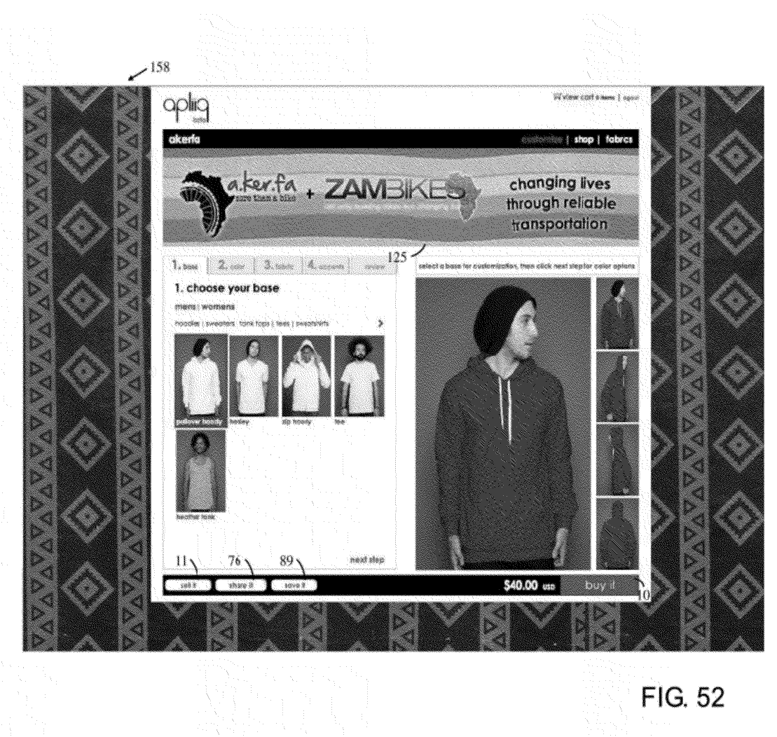

FIG. 52 illustrates a preferred embodiment of a User's Sub-Customizer Base tab in which the Store Owner selected certain Bases to offer for other Users to customize The Sub-Customizer displays the background (158) and header (125) uploaded by the Store Owner in their Store Owner Control's color tab (FIG. 47) as well as buttons to Sell It (11), Share It (76), Save It (89), and Buy It (10). Here, when Users clicks Save It, they can write a name and description for their Product and their Product can be added to the Sub-Store associated with the Sub-Customizer, to the Company's Primary Store, and to their Store Owner Control for future reference. The User's Sub-Customizer functions the same way the Company's primary Customizer functions (see FIGS. 10-13) with custom options determined by the Store Owner.

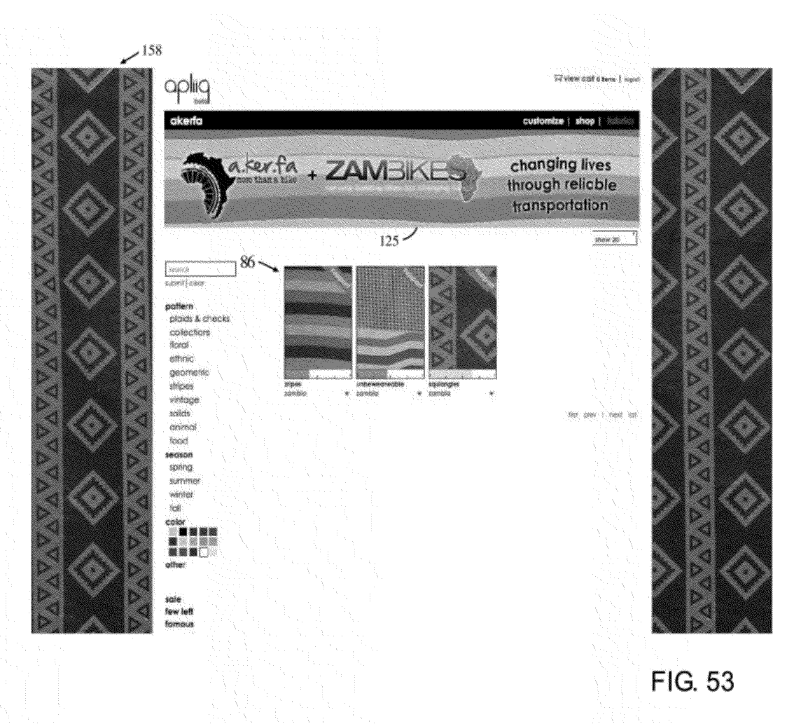

FIG. 53 illustrates a preferred embodiment of a User's Sub- Fabric Page that displays all Fabrics available in the Sub-Customizer and each Fabric image (86) and name link to Fabric Detail Pages for each Fabric. This page includes a header (125) and background (158) uploaded by the Store Owner in their Store Owner Control's color tab (FIG. 47) and functions the same way as the Company's primary Fabric Page (FIG. 41). The Fabric Detail Page displays a description and additional details about the Fabric with links to Share It, Sell It and Customize with It, which loads the Fabric into the associated Sub-Customizer (FIG. 52) with appropriate Bases that accept the Fabric.

It should now be appreciated that the present invention provides a computer system and methods with associated software that supports a Multi-Tier and Multi-Channel database for building custom Stores for buying and selling customizable Products or groups of Products. Users can customize products offered via the computer system, with data defining customized products created by the users being stored in a database. The computer system enables the Users to create online stores to offer and sell their customized and customizable products to others. Other users can create online sub-stores derived from an online store. The sub-stores allow the creators thereof to offer and sell their sub-customized products to others. The database stores data representative of the online stores and sub-stores in addition to the customized products and sub-products to be offered and sold via the online stores and sub-stores. The computer system uses the stored data to operate and maintain the online stores and sub-stores.

In an illustrated embodiment, the system of the invention is used to sell clothing, and in particular, Appliqué clothing. A Company that operates the system inputs data about every available Base and every available Component for customization (Product Management) which can be combined to create a finished Product. The Company can input, define, dictate and control each individual User's access, privileges and rewards, known as User Management.

The inventive system and methods allow for a virtually unlimited number of sales Channels. Each Channel can host an unlimited number of Tiers or Sub-Stores which, in turn, can host an unlimited number of Tiers or Sub-Stores in which the system can expand ad infinitum. A User can create his/her own custom selling environment to sell custom Products (Sub-Customizer). The database allows Users to build a virtually unlimited number of Sub-Customizers, each with different parameters for customization and his/her Store's display and layout.

The system of the invention can connect to a Just-in-Time manufacturing process in which all Products are made after Customers Order them. The database can gather Order data from all Stores in a centralized and secure location, referred to as the Order Management system. Upon receipt of an Order, the variable Components that make up a final Product can be purchased, assembled and shipped to the Customer through an Order Management interface. The Company that operates the system can systematically create reports to purchase Bases, manufacture finished Products, and pay Suppliers accurately and promptly through database driven functionality (the Accounting system). The Company can also view and track sales records between variable dates.

In the example implementation illustrated herein, the inventive system can save, segment and manage all the Components, Bases, and Patches in the database for custom Product creation. The Company running the system can input and save Base garments and corresponding information such as Name, Supplier Cost, Supplier Code, Price to charge the Customer, the location where the Base was found, the location where it was made, the Material composition, the Weight of the Base, the Season(s) that best correlate(s) to the Base, the available Colors and Sizes, and other relevant information. Layered photographs of models or other displays of Base garments and other Components can be uploaded in multiple views to facilitate customization. Base details such as Supplier Costs can be provided in the database to produce reports for an Accounting system for the Company to accurately pay Suppliers.

In the example implementation, the Company can also input and save Components and corresponding information such as Name, Description, City, State and Country of Origin, Texture, Thickness, Pattern type, Material composition, where the Component was Found, the Season(s) that best correlate(s) to the Component, the Persona(s) that best describe(s) to the Component, the Era the Component was created, the Suppliers Cost, any Colors that are present in the Component, the Quantity available of the Component, a Pre-Release and a Public-Release date for the Component, an image of the Component, and other relevant information. Component details such as Supplier Costs can be stored in the database to produce reports for an Accounting system for the Company to accurately pay Suppliers. An inventory of Components can be managed and tracked so that the system can display such information to the Users and the Company in different instances. Unique characteristics of Components can be saved in the system as searchable meta-tags for each Component or Product with the Component in a front end Store for Users and also in Product Management for the Company to access.

In the example implementation, The Company can further create and name Appliqué Patches. The Company can specify the Quantity of the Component used to create each Patch to track and manage the inventory of each Component. The Company can also specify the Production Cost of each Patch to track and manage all Costs from Manufacturers, as reported through an Accounting system. The Company is also able to specify the Patch Price which is displayed to the User as the total Price of a custom Product (composed of a Base and various Components) which is the sum of the Price of the selected Base and the Price of the selected Patches and selected Components.

Also in the example implementation, the system can segment Components (such as Fabrics) for specific Bases (such as garments) or specific Users or specific sales Channels. Base and Component information can be displayed as a singular Product and Product description when any series of Bases and Components are combined, saved, and displayed as a Product in any Store, any Customizer, the Checkout, Order Management system, or Accounting system.

The present invention also provides a computer implemented software and database system for creating a custom Product that can be purchased, shared, saved and sold on the Internet or other regional or global network through a system known as a Customizer. In the illustrated embodiment, custom Appliqué clothing can be purchased, sold, saved and shared using the Customizer. A User can manipulate the appearance of custom Products by selecting different Base garments, Colors, Fabrics, Patches, Patch Placements and Models. Custom clothing can be created where the Price to the User depends on the number and type of attributes (e.g., Appliqué patches) the User chooses for their clothing.

Moreover, the User can choose a particular Model from a set of models, and the chosen Model can be used to depict the Product being worn in every setting in which the Product appears such as a Store, a Customizer, or even external websites and social media networks. The User can also upload a photograph of him/herself or any other person to be used in depicting the Product being worn with selected Base and Components.

Still further, the illustrated embodiment discloses a computer system and methods for creating custom clothing where the quantity of fabric available for Appliqué on a Product is shown in a Fabric Meter which visually displays the quantity of fabric remaining on a scale from full to empty. The Fabric Meter can be implemented to change color and/or provide a corresponding text description depending on the quantity of fabric available.

In the inventive system, the Product (and all of the parts that compose it) can be saved to the database and displayed in a Store where it is available for purchase. Additionally, a custom Product (and all of the parts that compose it) can be saved in the database and corresponding metadata can be displayed in a Store's navigation directory that can be used to segment the Product during filtering and searching.

A User of the inventive system and methods, whether an individual, organization, team, school, group, business or other entity can generate revenue by creating a Sub-Store, becoming a Store Owner and selling Products. A Store Owner can sell Products that he/she designed or Products that other Users previously designed. A Store Owner can also create Product lines in specific colors or themes. Moreover, a Store Owner can personalize the appearance of his/her Store through Store Owner Controls by manipulating the images, colors, and/or text throughout his/her Sub-Store. A Store Owner can also create a Sub-Customizer and select a variety of Bases (such as garments) and Components (such as fabrics and other embellishments) to offer and display in his/her Sub-Customizer for other Users to Customize, Buy, Share and even Sell a complete Product. Initially, the selected Bases and Components can be chosen from respective libraries of Bases and Components provided by the system. Subsequent Users can create subsets, sub-subsets, etc. thereof from the online store they are using. These subsets, sub-subsets, etc. can be used as the basis for Product offerings on additional online Stores.

When the inventive system is used to sell clothing, as in the example illustrated embodiment, a Store Owner can select to offer and display Bases and Components in specified colors or themes. Specific Models can be selected to wear and display each Base that the Store Owner chooses to offer in his/her Sub-Customizer for other Users to see. A Store Owner can view the sales they have generated and be rewarded for them—financially, emotionally or otherwise.

A Storeowner can create, maintain and alter the appearance of his/her Store through a user interface provided by the system. Store Owner Controls are provided via the user interface to enable the user to manipulate the images, colors, and/or text throughout his/her Sub-Customizer. The Store Owner can enable Sub-Stores that sell on the Store Owner's behalf. The Store Owner can also determine the reward or commission for all associated Sub-Stores selling on his/her behalf. Still further, a Store Owner can offer unique Bases or Components that are exclusively available from that Store Owner's Sub-Customizer.

The computerized software and database system of the invention can manage and track Orders from transaction through delivery. It can also enable automated email communication with customers. Reports can be generated for purchasing Bases and Components from Suppliers and assigning Orders to Manufacturers (in the illustrated embodiment, sewing contractors) and receiving finished Products. An Operator can generate a Purchase Order for the Supplier by requesting the database to add Bases or Components (and simultaneously their attributes such as style, size, color, and cost) from a list of Products Ordered by Customers. The Operator receives Bases or Components from the Supplier, and subsequently adds the associated Orders from the Base Purchase Order to a Production Ticket. The Production Ticket provides a list that denotes Order details to enable Production by a customization Manufacturer. The Operator receives a finished Product from the customization Manufacturer and adds the items from the accepted Production Ticket to a list for packaging and shipping or packaging and pickup.

A Customer is notified of shipping (or that the Product is ready for pick up) and the tracking number of the package when it is shipped out by the Company. The system of the invention can also track refunds, exchanges, cancelled Orders, and other customer service issues, concerns and complaints. Quality assurance checks are allowed for at each level in Order Management system, where an Operator can deny an Order from continuing in the manufacturing process and send the Order back to the Base Purchase Order list to be made again.

Although the invention has been described in accordance with a particular example embodiment, those skilled in the art will appreciate that many other embodiments, variations and modifications can be provided using the teachings of the invention, all of which are intended to be included within the scope of the claims.

What is claimed is:

1. A computer system for creating and maintaining customized online stores comprising:
a computer processor;
a database associated with said processor;
software adapted to run on said processor and store and retrieve data to and from said database;
a user interface operatively associated with said software and processor for enabling first users to select subsets of product components offered via said computer system to create online stores, said online stores enabling second users to create custom products using the subset of product components selected for that store;
said database storing data representative of said online stores and the subset of product components associated with each online store for use by said computer system in operating and maintaining the online stores.

2. A computer system in accordance with claim 1, wherein:
said user interface enables said second users to create online sub-stores to offer and sell their custom products to others.

3. A computer system in accordance with claim 2 wherein said user interface provides:
a selection of store components for customizing the online stores and sub-stores.

4. A computer system in accordance with claim 1, wherein:
said first users are enabled to customize products offered via said computer system to create customized products to be offered for sale on their online stores.

5. A computer system in accordance with claim 2 wherein:
said user interface enables said second users to select a subset of said product components to present to users of their online sub-stores for creating sub-customized products.

6. A computer system in accordance with claim 5 wherein:
the users creating sub-customized products are enabled to create online sub-stores to offer and sell their sub-customized products to others; and
said interface enables the users creating sub-customized products to select a further subset of said product components to present on their online sub-stores.

7. A computer system in accordance with claim 1 wherein said interface enables:
a second user to select a second subset of product components from the product components presented on a respective first online store; and
said second user to create an online sub-store to allow others to create customized products using the second subset of components.

8. A computer system in accordance with claim 7 wherein said user interface enables users to link their stores and sub-stores to social media sites.

9. A computer system in accordance with claim 7 wherein said user interface enables a creator of a first store to configure payment structures for sub-stores created by others and associated with said first store.

10. A computer system in accordance with claim 7 wherein said user interface enables users to embed their online stores and sub-stores in other web sites.

11. A computer system in accordance with claim 1 wherein said user interface provides:
a selection of store components for customizing the online stores.

12. A computer system in accordance with claim 11 wherein:
said products comprise clothing; and
said store components comprise a selection of models that users can select to provide representations of their customized clothing being worn.

13. A computer system in accordance with claim 1 wherein:
said products comprise clothing; and
said user interface provides a fabric meter indicative of an amount of fabric remaining in inventory for manufacturing a customized product ordered from an online store.

14. A computer system in accordance with claim 1 wherein:
said user interface enables said first users to customize products offered via said computer system to create custom products to be offered for sale on their online stores;
said user interface enables said second users to create online sub-stores to offer and sell their custom products to others; and
said first and second users are compensated by an operator of the computer system based on sales of their respective custom products.

15. A computer system in accordance with claim 1 wherein:
users are enabled to customize products offered via said computer system as well as via said online stores to create sub-customized products.

16. A method for selling customized products and creating customized online stores comprising the steps of:
providing a network accessible computer system having a database associated therewith;
enabling first users to access said computer system via said network in order to perform at least one of:
(a) customizing products offered via the computer system,
(b) choosing a subset of product components offered via the computer system;
storing data in said database indicative of at least one of customized products designed and subsets of product components chosen by said first users;
enabling said first users to choose at least one of:
(i) purchasing their customized products,
(ii) creating online stores, each offering a respective one of said subsets of product components to allow others to customize products using the respective subset of product components;
storing data in said database representative of online stores created; and
allowing said online stores to be accessed by others via said network for the design and purchase of customized products.

17. A method in accordance with claim 16 comprising:
enabling second users to customize products offered via said online stores to create sub-customized products;
storing data in said database indicative of sub-customized products created by said second users; and
enabling said second users creating sub-customized products to choose at least one of:
(i) purchasing their sub-customized products,
(ii) creating online sub-stores to offer and sell their sub-customized products to others;
storing data in said database representative of online sub-stores created; and
allowing said online sub-stores to be accessed by others via said network for the purchase of the sub-customized products.

18. A method in accordance with claim 17 comprising:
enabling additional users to customize products offered via said online sub-stores to create additional sub-customized products;
storing data in said database indicative of additional sub-customized products created by said additional users; and
enabling said additional users creating additional sub-customized products to choose at least one of:
(i) purchasing their additional sub-customized products,
(ii) creating additional online sub-stores to offer and sell their additional sub-customized products to others;
storing data in said database representative of additional online sub-stores created; and
allowing said additional online sub-stores to be accessed by others via said network for the purchase of the additional sub-customized products.

19. A method in accordance with claim 18 comprising:
enabling the creator of an online store or sub-store to configure payment structures for sub-stores created by others and associated with that online store or sub-store.

20. A method in accordance with claim 18 comprising:
enabling first, second and additional users to link their stores and sub-stores to social media sites.

21. A method in accordance with claim 18 comprising:
enabling first, second and additional users to embed their stores and sub-stores in different web sites.

22. A method in accordance with claim 18 wherein the creators of stores and sub-stores are compensated by an operator of the computer system based on sales of their respective customized products and sub-customized products.

23. A method in accordance with claim 18 wherein:
said second users are enabled to customize products offered via said computer system as well as via said online stores to create sub-customized products; and
said additional users are enabled to customize products offered via said computer system and said online stores as well as via said online sub-stores to create said additional sub-customized products.

24. A method in accordance with claim 17 wherein:
said second users are enabled to customize products offered via said computer system as well as via said online stores to create sub-customized products.

25. A method in accordance with claim 16 wherein:
said products comprise clothing; and
a selection of models is provided that users can select to provide representations of their customized clothing being worn.

26. A method in accordance with claim 16 wherein:
said products comprise clothing; and
a fabric meter is provided indicative of an amount of fabric remaining in inventory for manufacturing a customized product ordered.

27. A method for selling customized products and creating customized online stores comprising the steps of:
providing a network accessible computer system having a database associated therewith, said database including a library of components for use in customizing products;
enabling first users to access said computer system via said network to select a subset of said library of components;
storing data in said database indicative of the subset of components;
enabling said first users to create online stores offering products and said subset of components for use in customizing the products;
storing data in said database representative of said online stores; and
allowing others to access said online stores via said network and to customize and purchase the products offered via the online stores using the subset of components.

28. A method in accordance with claim 27 comprising:
enabling a second user to select a sub-subset of the components offered via an online store;
storing data in said database indicative of the sub-subset of components;
enabling said second user to create an online sub-store offering products and said sub-subset of components for use in customizing products offered in the sub-store;
storing data in said database representative of online sub-stores created; and
allowing others to access said online sub-store via said network and to customize and purchase the products offered via the online sub-store using the sub-subset of components.

29. A method in accordance with claim 28 wherein:
said second users are enabled to select sub-subsets from the library of components offered via said computer system as well sub-subsets of the components offered via said online store.

30. A method in accordance with claim 28 comprising:
enabling others to create sub-sub-stores offering products and sub-sub-subsets of the components for use in customizing and purchasing products offered in the sub-sub-stores.

31. A computerized multi-tier, multi-channel sales system having an integrated accounting system comprising:
means for tracking connections between stores and sub-stores that are part of said sales system;
means for establishing and maintaining compensation structures for owners of said stores and sub-stores; and
means for tracking and maintaining a history of sales made via said stores and sub-stores and earnings attributable to said owners as a result of said sales based on said compensation structures.
